(19) United States
(12) Patent Application Publication
(10) Pub. No.: US 2022/0287375 A1
(43) Pub. Date: Sep. 15, 2022

(54) AN AEROSOL-GENERATING SYSTEM AND AN INTERFACE ELEMENT FOR AN AEROSOL-GENERATING SYSTEM

(71) Applicant: Philip Morris Products S.A., Neuchatel (CH)

(72) Inventor: Rui Nuno BATISTA, Neuchatel (CH)

(73) Assignee: Philip Morris Products S.A., Neuchatel (CH)

(21) Appl. No.: 17/635,255

(22) PCT Filed: Aug. 17, 2020
(86) PCT No.: PCT/EP2020/072979

§ 371 Date: Feb. 14, 2022

(30) Foreign Application Priority Data
Aug. 21, 2019 (EP) 19192959.5

(51) Int. Cl. A24F 40/51; A24F 40/53; A24F 40/60; A24F 40/49

(52) U.S. Cl. CPC A24F 40/51; A24F 40/53; A24F 40/60; A24F 40/49

(57) ABSTRACT

An aerosol-generating system is provided, including: an aerosol-generating element; a housing including an upper surface, a lower surface, and a plurality of regions; an interface element including a plurality of contact sensing elements, each contact sensing element being configured to generate an input signal responsive to that contact sensing element detecting contact with the upper surface at or near one of the plurality of regions; and a circuit configured to receive the input signals from the plurality of contact sensing elements and to enable a first function of the aerosol-generating system responsive to a first plurality of the input signals satisfying a first criterion, satisfaction of the first criterion being part of a multi-step authentication procedure, the first criterion including the circuit receiving a predefined number of the input signals simultaneously. A method of operating an aerosol-generating system including an aerosol-generating element is also provided.

The present invention relates to an aerosol-generating system, to a device for use with the system, and to a method of generating an aerosol. In particular, the invention relates to handheld aerosol-generating systems and devices which vaporise an aerosol-forming substrate by heating to generate an aerosol to be puffed or inhaled by a user, and which include an interface element.

One type of aerosol-generating system generates, using electrical heating, an aerosol for a user to puff or inhale. Such electrically heated aerosol-generating systems come in various forms. Some types of such systems are e-cigarettes that vaporise a liquid or gel substrate to form an aerosol, or release an aerosol from a solid substrate by heating it to a certain temperature below the combustion temperature of the solid substrate.

Handheld electrically operated aerosol-generating devices and systems are known that consist of a device portion comprising a battery and control electronics, a portion for containing or receiving an aerosol-forming substrate and an electrically operated heater for heating the aerosol-forming substrate to generate an aerosol. A mouthpiece portion is also included on which a user may puff to draw aerosol into their mouth.

Some devices and systems use a liquid or gel aerosol-forming substrate stored in a storage portion. Such devices may use a wick to carry the liquid or gel aerosol-forming substrate from the storage portion to the heater where it is aerosolised. Such devices may use a displacement mechanism such as a pump and piston to displace the liquid or gel aerosol-forming substrate from the storage portion to the heater. Other types of aerosol-generating devices and systems use a solid aerosol-forming substrate that includes a tobacco material. Such devices may comprise a recess for receiving a cigarette-shaped rod comprising the solid aerosol-forming substrate, such as folded sheets that include a tobacco material. A blade-shaped heater arranged in the recess is inserted into the centre of the rod as the rod is received in the recess. The heater is configured to heat the aerosol-forming substrate to generate an aerosol without substantially combusting the aerosol-forming substrate.

Electrically heated aerosol-generating systems may provide a significantly different user experience than a conventional, combustion-based cigarette. For example, the user interacts with a device rather than lighting a cigarette. The electrically heated aerosol-generating system may be activated using a mechanical on/off button. However the mechanical button may provide the user with only limited interaction with the system, and may allow unauthorized users to use the system. Additionally, a mechanical button introduces potential mechanical failure of control components of the system (such as the button or electrical circuitry coupled thereto) over time. For example, cyclic loading may lead to wear, cyclic fatigue of the control components, or the like. Some devices provide more than one button to increase possible interactions between the user and system, for example to give the user more control of system functionality, to initiate different processes, or the like. Some devices may include a touch screen or biometric sensor for receiving user input or for authenticating the user. However, these different interactions may be confusing for the user, and introduce more components that are susceptible to failure and have an associated manufacturing cost.

An objective of the present invention is to provide the user with easily understandable feedback that conveys meaningful information. Another objective of the present invention is to inhibit unauthorized users from using the system. Another objective of the present invention is to provide an appealing smooth and contiguous outer surface of the system. Another objective of the present invention is to reduce mechanical components used in the system.

According to an aspect of the present invention, there is provided an aerosol-generating system. The system may comprise a housing. The housing may comprise an upper surface. The housing may comprise a lower surface. The housing may comprise a plurality of regions. The system may comprise an interface element. The interface element may comprise a plurality of contact sensing elements. Each contact sensing element may be configured to generate an input signal responsive to that contact sensing element detecting contact with the upper surface at or near one of the plurality of regions. The system may comprise a circuit configured to receive the input signals from the plurality of contact sensing elements. The circuit may be configured to enable a first function of the aerosol-generating system responsive to a first plurality of the input signals satisfying a first criterion. The first criterion may comprise the circuit receiving a predefined number of the input signals simultaneously.

According to an embodiment, there is provided an aerosol-generating system comprising a housing comprising an upper surface, a lower surface, and a plurality of regions. The system comprises an interface element comprising a plurality of contact sensing elements, each contact sensing element being configured to generate an input signal responsive to that contact sensing element detecting contact with the upper surface at or near one of the plurality of regions. The system also comprises a circuit configured to receive the input signals from the plurality of contact sensing elements and to enable a first function of the aerosol-generating system responsive to a first plurality of the input signals satisfying a first criterion, wherein the first criterion comprises the circuit receiving a predefined number of the input signals simultaneously.

In use, determining whether the first criterion is satisfied may be, or may be part of, an authentication procedure. In use, a user may hold, or otherwise place their hand on, the housing. Each of a number of contact sensing elements may then generate an input signal responsive to that contact sensing element detecting contact with the upper surface at or near one of the plurality of regions. The number of input signals generated may act as an indicator of the size of the hand of the user. The number of input signals generated may indicate whether the user is a specified user, or an approved type of user. For example, generation of fewer than the predefined number of input signals (and receipt by the circuit of fewer than the predefined number of input signals) may indicate that the user is a child with small hands. As such, the first criterion may not be satisfied and the first function may not be enabled. Conversely, generation of exactly, or more, than the predefined number of input signals (and receipt by the circuit of exactly, or more than, than the predefined number of input signals) may indicate that the user has large hands, and is therefore an adult. As such, the first criterion may be satisfied and the first function may be enabled.

Advantageously, the first criterion may act as a novel and reliable authentication procedure. Advantageously, satisfying the first criterion may not require the system to have any moving parts. Advantageously, the satisfying the first criterion may not require the use of any biometric sensors such as fingerprint sensors. This may reduce a cost of manufacture of the system.

For the avoidance of doubt, unless otherwise specified, receipt of a predefined number of the signals simultaneously includes receipt of exactly the predefined number of the signals simultaneously, as well as receipt of more than the predefined number of the signals simultaneously.

The predefined number may correspond to a number of input signals expected to be generated by contact with the upper surface by a specified user or an approved type of user, for example by a hand of a specified user or of an approved type of user.

Advantageously, this may allow the system to enable the first function only for a specified user or an approved type of user.

The predefined number may correspond to a number of input signals expected to be generated by contact with the upper surface by a hand of at least a predetermined size. The hand being at least the pretermined size may indicate that the user is a specified user, or an approved type of user. The hand being at least the pretermined size may indicate that the user is an adult.

Advantageously, this may allow the system to enable the first function only for a user with a hand of at least a predetermined size. This may mean that the first function is not enabled for a user with a hand of less than the predetermined size. Thus, children with small hands may be prevented from enabling the first function.

The predefined number may correspond to a number of input signals generated by contact with a predetermined proportion of a surface, or of a portion of a surface, of the housing. For example, the predefined number may correspond to a number of input signals generated by contact with more than 10, 20, 30, 40, 50, or 60% of a surface, or a portion of a surface, of the housing, for example a front-facing surface of the housing or a rear-facing surface of the housing. Advantageously, this may provide a reliable way to determine a size of a hand of the user. Thus, this may provide a reliable way to prevent children with small hands may be prevented from enabling the first function.

The predefined number may correspond to a number of input signals generated by contact with a predetermined proportion of the upper surface of the housing or of a portion of the upper surface of the housing. For example, the predefined number may correspond to a number of input signals generated by contact with more than 10, 20, 30, 40, 50, or 60% of the upper surface of the housing, or more than 10, 20, 30, 40, 50, or 60% of a portion of the upper surface of the housing, for example a front-facing upper surface of the housing or a rear-facing upper surface of the housing. Advantageously, this may provide a reliable way to determine a size of a hand of the user. Thus, this may provide a reliable way to prevent children with small hands may be prevented from enabling the first function.

At least one of the plurality of contact sensing elements may comprise a heat sensing element.

At least one of the plurality of contact sensing elements may comprise a capacitive sensor.

At least one of the plurality of contact sensing elements may comprise a pressure sensor.

Determining whether or not the first criterion is satisfied may be part of a multi-step authentication procedure.

Advantageously, a multi-step authentication procedure may improve the security of the system.

The first function may be initiation of an authentication procedure. Where satisfying the first criterion is itself considered an authentication procedure, this first function may be considered initiation of a second authentication procedure. Advantageously, this may improve the security of the system.

The circuit may be configured to enable the first function if an alternative authentication procedure to satisfying the first criterion is successfully completed. The system may be configurable, for example by a user, such that the circuit is configured to enable the first function if an alternative authentication procedure to satisfying the first criterion is successfully completed. The system may be configurable, for example by a user, between a first state in which satisfying the first criterion is essential for enabling the first function and a second state in which the circuit is configured to enable the first function if an alternative authentication procedure to satisfying the first criterion is successfully completed.

The alternative authentication procedure may include one or more of:

using a fingerprint sensor to receive a fingerprint and comparing that fingerprint to a stored fingerprint;

using voice recognition technology, e.g., having the system ask the user a question, receiving a voice sample from the user in response to that question, and comparing the voice sample to prestored voice information (such as determining that the voice is below a certain frequency, or belongs to a particular user, or other determination such as commonly done in telephone banking technology);

receiving a password or code from the user, (such as a typed password, a touch pattern password, or an audio password).

Advantageously, this may allowed an approved user to enable the first function if they are unable to fulfil the first criterion, for example if the approved user has hands which are too small to be able to satisfy the first criterion, or if the interface element malfunctions.

The system, for example the circuit of the system, may be configured to determine a length of time for which at least one, or each, contact sensing element has detected contact with the upper surface at or near one of the plurality of regions.

The first criterion may comprise receiving the predefined number of input signals from the plurality of contact sensing elements, or a second predefined number of input signals from the plurality of contact sensing elements, indicative of contact with the upper surface for greater than a predetermined length of time.

The predetermined length of time may be greater than 0.1, 0.2, 0.5, 1, 2, 3, or 5 seconds. The predetermined length of time may be less than 10 or 5 seconds.

Advantageously, this may reduce a risk the first function being enabled inadvertently.

The first criterion may comprise receiving the predefined number of input signals from the plurality of contact sensing elements, or a second predefined number of input signals from the plurality of contact sensing elements, indicative of contact with the upper surface for less than a second predetermined length of time.

The second predetermined length of time may be less than 10 or 5 seconds. The second predetermined length of time may be greater than 1 second.

As an example, the first criterion may comprise receiving a second predefined number of input signals from the plurality of contact sensing elements indicative of contact with the upper surface for between 0.5 and 5 seconds, or between 1 and 5 seconds.

The first criterion may comprise simultaneously receiving a first predefined number of input signals responsive to detecting contact with the upper surface at or near a first region of the plurality of regions and a second predefined number of input signals responsive to detecting contact with the upper surface at or near a second region of the plurality of regions.

The first region may be separated from the second region by at least 5, 10, 20, or 50 millimetres.

The first region and the second region may not be located in a single plane. For example, the first region may be located at, near, or on a front-facing surface of the housing (such as a front-facing upper surface), and the second region may be located at, near or on a rear-facing or side-facing surface (such as a rear-facing or side-facing upper surface) of the housing.

The first criterion may comprise simultaneously receiving at least one input signal responsive from a contact sensing element detecting contact with a first portion of the upper surface and at least one input signal responsive from a contact sensing element detecting contact with a second portion of the upper surface. The first portion of the upper surface and the second portion of the upper surface may be non-co-planar. That is, the first portion of the upper surface and the second portion of the upper surface may occupy different planes. For example, the first portion may be located on a front-facing portion of the upper surface and the second portion may be located on a side-facing or rear-facing portion the upper surface.

The first criterion may comprise simultaneously receiving an nth predefined number of input signals responsive to detecting contact with the upper surface at or near an nth region of n regions of the plurality of regions, where n is an integer greater than, or equal to, 2.

The integer n may be, or may be at least, 3, 5, 10, 20, 50, or 100.

For example, the first criterion may comprise simultaneously receiving at least one input signal responsive to detecting contact with the upper surface at or near each of the n (for example 3, 5, 10, 20, 50, or 100) regions of the plurality of regions.

Each of the n regions may be spaced at least 0.1, 0.2, 0.5, 1, 2, 5, or 10 millimetres from every other region of the n regions.

For example, each of the 3, 5, 10, 20, 50, or 100 regions may be spaced at least 0.1, 0.2, 0.5, 1, 2, 5, or 10 millimetres from every other region of the 3, 5, 10, 20, 50, or 100 regions.

The first criterion may comprise simultaneously receiving at least one input signal responsive to detecting contact with the upper surface at or near more than a predetermined number or proportion of the n (for example 3, 5, 10, 20, 50, or 100) regions of the plurality of regions, for example more than 20%, 40%, 60%, 80%, or 90% of the number of regions. As the skilled person would appreciate, where such a proportion is not an integer, the proportion may be rounded to the nearest integer.

As an example, the first criterion may comprise simultaneously receiving at least one input signal responsive to detecting contact with the upper surface at or near each of 3 or 5 regions of the plurality of regions and each of the 3 or 5 regions may be spaced at least 2 or 5 millimetres from every other region of the 3 or 5 regions.

As another example, the first criterion may comprise simultaneously receiving at least one input signal responsive to detecting contact with the upper surface at or near each of 50 or 100 regions of the plurality of regions and each of the 50 or 100 regions may be spaced at least 0.1, 0.2, or 0.5 millimetres from every other region of the 50 or 100 regions.

As yet another example, the first criterion may comprise simultaneously receiving at least one input signal responsive to detecting contact with the upper surface at or near at least 60% or 80% of 20, 50 or 100 regions of the plurality of regions and each of the 20, 50 or 100 regions may be spaced at least 0.1, 0.2, or 0.5 millimetres from every other region of the 20, 50 or 100 regions.

At least 2 of the n regions may be located in different planes. At least 2 of the n regions may be located at, near, or on different surfaces of the housing, such as surfaces which are not co-planar. For example, at least one of the n regions may be located at, near or on a front-facing surface (such as a front-facing upper surface) of the housing and at least one of the n regions may be located at, near or on a rear-facing or side-facing surface (such as a rear-facing or side-facing upper surface) of the housing.

Advantageously, these features may give some indication as to where on the housing contact is being detected. This may allow the system to distinguish between, for example, two hands of a child contacting the upper surface and a single hand of an adult contacting the upper surface, even if the total area of contact in these two cases is identical. Thus, this may advantageously improve the security of the system.

The housing may be button-free. The housing may contain no moving parts.

Advantageously, this may reduce a risk of mechanical failure of the system.

According to an aspect of the present invention, there is provided a method of using an aerosol-generating system. The method may comprise generating, by an interface element comprising a plurality of contact sensing elements, a plurality of input signals responsive to detecting contact with an upper surface of a housing at or near respective regions of the housing. The method may comprise receiving, by a circuit, the plurality of input signals. The method may comprise enabling, by the circuit, a first function of the aerosol-generating system responsive to the plurality of input signals satisfying a first criterion. The first criterion may comprise the circuit receiving a predefined number of the input signals simultaneously.

According to an embodiment, there is provided a method of using an aerosol-generating system. The method comprises generating, by an interface element comprising a plurality of contact sensing elements, a plurality of input signals responsive to detecting contact with an upper surface of a housing at or near respective regions of the housing; receiving, by a circuit, the plurality of input signals; and enabling, by the circuit, a first function of the aerosol-generating system responsive to the plurality of input signals satisfying a first criterion. The first criterion comprises the circuit receiving a predefined number of the input signals simultaneously.

Advantageously, the first criterion may act as a novel and reliable authentication procedure. Advantageously, satisfying the first criterion may not require the system to have any moving parts. Advantageously, the satisfying the first criterion may not require the use of any biometric sensors such as fingerprint sensors. This may reduce a cost of manufacture of the system.

Features described above or below in relation to a device or system may equally be applicable to the method of using an aerosol-generating system described above.

The invention may provide an aerosol-generating system comprising a housing comprising an upper surface, a lower surface, and an at least partially transparent region extending between the upper surface and the lower surface. The aerosol-generating system may comprise an interface element. The interface element may comprise a contact sensing element configured to generate an input signal responsive to the contact sensing element detecting contact with the upper surface. The interface element may also comprise a light emitting element configured to transmit a first visible light signal through the at least partially transparent region responsive to a first output signal. The aerosol-generating system may comprise a circuit configured to receive the input signal from the contact sensing element and to transmit the first output signal to the light emitting element.

According to an embodiment, an aerosol-generating system may comprise a housing comprising an upper surface, a lower surface, and an at least partially transparent region extending between the upper surface and the lower surface. The aerosol-generating system comprises an interface element. The interface element comprises a contact sensing element configured to generate an input signal responsive to the contact sensing element detecting contact with the upper surface. The interface element also comprises a light emitting element configured to transmit a first visible light signal through the at least partially transparent region responsive to a first output signal. The aerosol-generating system comprises a circuit configured to receive the input signal from the contact sensing element and to transmit the first output signal to the light emitting element.

The present invention may enhance interaction with users by providing an interface element in an aerosol-generating system. The interface element includes a contact sensing element that detects contact with the upper surface, and optionally includes a light emitting element. Any suitable component of the interface element, e.g., the contact sensing element or the light emitting element, or both the contact sensing element and the light emitting element, optionally may be disposed below the housing. The housing optionally is at least partially transparent. The housing optionally is smooth and contiguous. It will be appreciated that the present interface elements may provide information to or receive information from the user while avoiding or reducing the need for mechanical interface components, touch screens, or biometric sensors. The present interface elements potentially may improve the experience for the user and improve device cost, lifetime, and management.

Optionally, the contact sensing element comprises a heat sensing element. The light emitting element optionally comprises a light emitting diode.

The light emitting element optionally is configured to transmit a second visible light signal through the at least partially transparent region responsive to a second output signal received from the circuit, wherein the second visible light signal comprises a different wavelength than the first visible light signal.

Optionally the aerosol-generating system further may comprise a flexible printed circuit board comprising the circuit and the interface element.

The circuit optionally may be configured to transmit the first output signal to the light emitting element responsive to receiving the first input signal from the contact sensing element.

The at least partially transparent region optionally may comprise a recessed portion of the housing. Optionally, the aerosol-generating device further comprises a material disposed in a recessed portion of the housing. The material optionally is configured to change an optical property of the first visible light signal.

The upper surface of the housing optionally may be substantially flat over the at least partially transparent region.

The system optionally may include an aerosol-generating device to which the housing, and the interface element is coupled. The system optionally may include a peripheral device to which the interface element is coupled.

The interface element optionally further may comprise a plurality of additional contact sensing elements and a plurality of additional light emitting elements. The circuit optionally is configured to receive a respective input signal from each of the additional contact sensing elements and to transmit a respective first output signal to each of the additional light emitting elements.

An aerosol-generating system may comprise a housing comprising an upper surface, a lower surface, and a plurality of regions. The aerosol-generating system may comprise an interface element comprising a plurality of contact sensing elements. Each contact sensing element may be configured to generate a respective input signal responsive to that contact sensing element detecting contact with the upper surface at or near a respective one of the regions. The aerosol-generating system may comprise a circuit configured to receive the respective input signals from the contact sensing elements and to enable a first function of the aerosol-generating system responsive to a first plurality of the respective input signals satisfying a first criterion.

For example, an aerosol-generating system may comprise a housing comprising an upper surface, a lower surface, and a plurality of regions. The aerosol-generating system comprises an interface element comprising a plurality of contact sensing elements. Each contact sensing element is configured to generate a respective input signal responsive to that contact sensing element detecting contact with the upper surface at or near a respective one of the regions. The aerosol-generating system comprises a circuit configured to receive the respective input signals from the contact sensing elements and to enable a first function of the aerosol-generating system responsive to a first plurality of the respective input signals satisfying a first criterion.

Optionally, the first criterion comprises the circuit receiving a predefined number of the respective input signals at the same time as one another. Alternatively, the first criterion optionally comprises the circuit receiving predefined ones of the respective input signals in a first predefined sequence.

Each of the contact sensing elements optionally may comprise a heat sensing element.

Each region of the plurality of regions optionally may be at least partially transparent. Optionally, the interface element further comprises a plurality of light emitting elements. Each light emitting element optionally is configured to transmit a respective visible light signal through a respective one of the regions responsive to a respective output signal. Optionally, the circuit is configured to respectively transmit the output signal to each of the light emitting elements.

The enabled first function of the aerosol-generating system optionally may comprise the circuit transmitting the respective output signal to a first plurality of the light emitting elements so as to cause the plurality of the light emitting elements to transmit respective visible light signals through respective ones of the regions. As a further option, the plurality of the light emitting elements comprises a predefined subset of the light emitting elements.

The circuit optionally may be configured to enable a second function of the aerosol-generating system responsive to a second plurality of the input signals satisfying a second criterion. As a further option, the second criterion comprises the circuit receiving predefined ones of the respective input signals in a second predefined sequence. Optionally, the second predefined sequence is user-defined.

The aerosol-generating system optionally further may comprise an aerosol-generating element. Optionally, the first function comprises actuating the aerosol-generating element.

Optionally, the housing may be button-free. Optionally, the upper surface of the housing may be substantially smooth and contiguous.

Features of any aerosol-generating system described herein may be applied to any other aerosol-generating system described herein. For example, optional features described in relation to any aerosol-generating system described herein may be equally applied to any other aerosol-generating system described herein.

As used herein, the term ‘aerosol-generating system’ relates to a system that includes one or more components that may interact with one another. One component that an ‘aerosol-generating system’ may include is an aerosol-generating device. Another component that an ‘aerosol-generating system’ can include is an aerosol-forming substrate to generate an aerosol. Another component that an ‘aerosol-generating system’ may include is a peripheral device. An ‘aerosol-generating system’ optionally may include an aerosol-generating device, an aerosol-forming substrate (e.g., provided within an aerosol-generating article), and any suitable number of peripheral devices.

As used herein, the term ‘aerosol-generating article’ relates to an article comprising an aerosol-forming substrate. Optionally, the aerosol-generating article also comprises one or more further components, such as a reservoir, carrier material, wrapper, etc. An aerosol-generating article may generate an aerosol that is directly inhalable into a user's lungs through the user's mouth. An aerosol-generating article may be disposable. An aerosol-generating article comprising an aerosol-forming substrate comprising tobacco may be referred to as a tobacco stick. As used herein, the term ‘aerosol-forming substrate’ relates to a substrate capable of releasing one or more volatile compounds that may form an aerosol. Such volatile compounds are released by heating the aerosol-forming substrate to form a vapour. The vapour may condense to form an aerosol, for example a suspension of fine solid particles or liquid droplets in a gas such as air. An aerosol-forming substrate may conveniently be part of an aerosol-generating system. In some configurations, the aerosol-forming substrate comprises a gel or liquid, while in other configurations, the aerosol-forming substrate comprises a solid. The aerosol-forming substrate may comprise both liquid and solid components.

As used herein, the term ‘aerosol-generating device’ relates to a component of an aerosol-generating system that interacts with the aerosol-forming substrate of the aerosol-generating article to generate an aerosol.

As used herein, the term ‘peripheral device’ relates to a device that is part of an aerosol-generating system and interacts directly or indirectly with an aerosol-generating device, but is not itself an aerosol-generating device. Examples of peripheral devices include, but are not limited to, a charger for the aerosol-generating device, a charging case for the aerosol-generating device, a holder for one or more aerosol-generating articles, or a vending machine configured to sell the aerosol-generating device or aerosol-generating articles.

As used herein, the term ‘coupled’ relates to an arrangement of elements that may be directly or indirectly in contact with one another. Elements that are ‘directly’ coupled to one another touch one another. Elements that are ‘indirectly’ coupled to one another do not directly touch one another, but are attached to one another via one or more intermediate elements. Depending on the particular arrangement, elements that are part of the same device or system as one another may be ‘directly’ in contact with one another or ‘indirectly’ in contact with one another.

As used herein, the terms ‘upper’ and ‘lower’ relate to the relative positions of portions of an element when the element is in an upright position. When describing housing surfaces according to the present invention, these terms are used irrespective of the orientation of the housing surface.

As used herein, the terms ‘upper surface’ and ‘lower surface’ respectively relate to opposing major surfaces of an element. The upper surface and lower surface of the element may be separated from one another by a thickness of the element.

As used herein, the term ‘outer surface’ relates to a surface of an element that is facing towards the exterior of an aerosol-generating system or device. An ‘upper surface’ of the housing of the aerosol-generating system or a device also is an ‘outer surface’ of such system or device, irrespective of the orientation of the aerosol-generating system or device.

As used herein, the term ‘substantially flat’ relates to an element that is formed in a single plane and for example not wrapped around or otherwise conformed to fit a curved or non-planar shape. One region of an element may be substantially flat, while another region of the same element may be curved or otherwise nonplanar.

As used herein, the term ‘interface element’ relates to an element through which information may be transmitted, through which information may be received, or through which information may be both transmitted and received. An exemplary interface element provided herein includes a light emitting element for transmitting information, and a contact sensing element for receiving information.

As used herein, the term ‘light emitting element’ relates to an element that generates light, such as a visible light signal.

As used herein, the term ‘visible light signal’ relates to light having a wavelength and an intensity such that a user may perceive the light via the user's sense of sight. A visible light signal is in the optical range of the electromagnetic spectrum, and includes one or more wavelengths in the range of about 380 to about 740 nanometers to which the human eye typically responds.

As used herein, the term ‘at least partially transparent’ relates to an element having the ability to transmit a visible light signal therethrough.

As used herein, the term ‘contact sensing element’ relates to an element that detects contact by a user. Typically, such contact of a contact sensing element is with a body part of the user, such as one or more of a finger, palm, or lip of the user. Non-limiting examples of contact sensing elements include capacitive sensors, pressure sensors, and heat sensing elements. Contact may include a movement, a tap (which may be long or short), or a prolonged touch.

As used herein, the term ‘heat sensing element’ relates to a contact sensing element that detects contact by a user via heat transferred from the user to the heat sensing element during such contact.

As used herein, the term ‘thermal communication’ relates to elements that are coupled to one another in such a manner that the temperature of one such element affects the temperature of another such element. For example, thermal communication between a user and a heat sensing element transfers heat from the user to the heat sensing element and thus affects the temperature of the heat sensing element. Such thermal communication may be via one or more intermediate elements. For example, a user may contact and thus be in thermal communication with an upper surface of a housing that is in thermal communication with a heat sensing element, and therefore the user may be in thermal communication with the heat sensing element via the housing.

As used herein, the term ‘detectable temperature change’ relates to a change of temperature that may be detected by a heat sensing element. Examples of detectable temperature changes by a heat sensing element may include, for example, a temperature increase of about 0.02 degrees Celsius or greater, or a temperature increase of about 0.05 degrees Celsius or greater, or a temperature increase of about 0.1 degrees Celsius or greater, or a temperature increase of about 0.2 degrees Celsius or greater, or a temperature increase of about 0.5 degrees Celsius or greater, or a temperature increase of about 1 degree Celsius or greater, or a temperature increase of about 2 degrees Celsius or greater, or a temperature increase of about 5 degrees Celsius or greater, or a temperature increase of about 10 degrees Celsius or greater, or a temperature increase of 15 degrees Celsius or greater, or a temperature increase of 20 degrees Celsius or greater, or a temperature increase of 25 degrees Celsius or greater, or a temperature increase of 30 degrees Celsius or greater. For example, the detectable temperature increase may be in a range of about 0.02 degrees Celsius to about 5 degrees Celsius, or about 0.05 degrees Celsius to about 2 degrees Celsius, or about 0.1 degrees Celsius to about 1 degrees Celsius. Alternatively, the detectable temperature increase may be in a range of about 0.02 degrees Celsius to about 10 degrees Celsius, or may be in a range of about 0.05 degrees Celsius to about 10 degrees Celsius, or may be in a range of about 0.1 degrees Celsius to about 10 degrees Celsius, or may be in a range of about 0.1 degrees Celsius to about 10 degrees Celsius, or may be in a range of about 0.2 degrees Celsius to about 10 degrees Celsius, or may be in a range of about 0.5 degrees Celsius to about 10 degrees Celsius, or may be in a range of about 1 degree Celsius to about 10 degrees Celsius, or may be in a range of about 0.05 degrees Celsius to about 5 degrees Celsius, or may be in a range of about 0.1 degrees Celsius to about 5 degrees Celsius, or may be in a range of about 0.5 degrees Celsius to about 5 degrees Celsius, or may be in a range of about 0.5 degrees Celsius to about 2 degrees Celsius, or may be in a range of about 0.02 degrees Celsius to about 35 degrees Celsius, or may be in a range of about 0.05 degrees Celsius to about 35 degrees Celsius, or may be in a range of about 0.1 degrees Celsius to about 35 degrees Celsius, or may be in a range of about 0.1 degrees Celsius to about 35 degrees Celsius, or may be in a range of about 0.2 degrees Celsius to about 35 degrees Celsius, or may be in a range of about 0.5 degrees Celsius to about 35 degrees Celsius, or may be in a range of about 1 degree Celsius to about 35 degrees Celsius. In one nonlimiting example, the detectable temperature increase is the temperature difference between (i) the temperature of the heat sensing element before that element is contacted by the user, and (ii) the temperature of the heat sensing element after that element is contacted by the user, for example during contact between that element and the user. The contact of the heat sensing element by a user in (ii) may be defined by a start of contact and an end of contact. The temperature of the heat sensing element in (ii) may be measured between the start of contact and the end of contact i.e. during actual contact, or may be measured within a short period after the end of contact. For example, the temperature of the heat sensing element in (ii) may be measured between about 0 seconds and about 5 seconds, or about 0 seconds and about 3 seconds, or about 0 seconds and about 1 second, after the end of contact. Optionally, the temperature of the heat sensing element in (ii) is approximately normal human skin temperature, i.e., about 28 to about 36, or about 30 to about 36, or about 31 to about 35 degrees Celsius.

Other examples of detectable temperature changes by the heat sensing element may include, for example, a temperature decrease of about 0.02 degrees Celsius or greater, or a temperature decrease of about 0.05 degrees Celsius or greater, or a temperature decrease of about 0.1 degrees Celsius or greater, or a temperature decrease increase of about 0.2 degrees Celsius or greater, or a temperature decrease of about 0.5 degrees Celsius or greater, or a temperature decrease of about 1 degrees Celsius or greater, or a temperature decrease of about 2 degrees Celsius or greater, or a temperature decrease of about 5 degrees Celsius or greater, or a temperature decrease of about 10 degrees Celsius or greater, or a temperature decrease of 15 degrees Celsius or greater, or a temperature decrease of 20 degrees Celsius or greater, or a temperature decrease of 25 degrees Celsius or greater, or a temperature decrease of 30 degrees Celsius or greater. For example, the detectable temperature decrease may be in a range of about 0.02 degrees Celsius to about 5 degrees Celsius, or about 0.05 degrees Celsius to about 2 degrees Celsius, or about 0.1 degrees Celsius to about 1 degrees Celsius. Alternatively, the detectable temperature decrease may be in a range of about 0.02 degrees Celsius to about 10 degrees Celsius, or may be in a range of about 0.05 degrees Celsius to about 10 degrees Celsius, or may be in a range of about 0.1 degrees Celsius to 10 degrees Celsius, or may be in a range of about 0.1 degrees Celsius to about 10 degrees Celsius, or may be in a range of about 0.2 degrees Celsius to about 10 degrees Celsius, or may be in a range of about 0.5 degrees Celsius to about 10 degrees Celsius, or may be in a range of about 1 degree Celsius to about 10 degrees Celsius, or may be in a range of about 0.05 degrees Celsius to about 5 degrees Celsius, or may be in a range of about 0.1 degrees Celsius to about 5 degrees Celsius, or may be in a range of about 0.5 degrees Celsius to about 5 degrees Celsius, or may be in a range of about 0.5 degrees Celsius to about 2 degrees Celsius.

The aerosol-generating system may include a gel, liquid, or solid aerosol-forming substrate, and may include a suitably configured aerosol-generating element configured as to generate an aerosol therefrom.

In configurations in which the aerosol-forming substrate comprises a gel or liquid, the aerosol-generating system may include a reservoir holding the aerosol-forming substrate, which reservoir optionally may contain a carrier material for holding the aerosol-forming substrate. The carrier material optionally may be or include a foam, a sponge, or a collection of fibres. The carrier material optionally may be formed from a polymer or co-polymer. In one embodiment, the carrier material is or includes a spun polymer.

In some configurations, the aerosol-generating system optionally comprises a cartridge and a mouthpiece couplable to the cartridge. The cartridge optionally comprises at least one of the reservoir and the aerosol-generating element. The housing of the aerosol-generating system optionally further may comprise an air inlet, an air outlet, and an airflow path extending therebetween, wherein the vapour optionally at least partially condenses into an aerosol within the airflow path.

For example, in various configurations provided herein, the cartridge may comprise a housing having a connection end and a mouth end remote from the connection end, the connection end configured to connect to an aerosol-generating device of an aerosol-generating system. The aerosol-generating element may be located fully within the cartridge, or located fully within the aerosol-generating device, or may be partially located within the cartridge and partially located within the aerosol-generating device. Electrical power may be delivered to the aerosol-generating element from the connected aerosol-generating device through the connection end of the housing. In some configurations, the aerosol-generating element optionally is closer to the connection end than to the mouth end opening. This allows for a simple and short electrical connection path between a power source in the aerosol-generating device and the aerosol-generating element.

The aerosol-generating element, which optionally is or includes a heating element, may be substantially planar. The heating element may comprise a resistive material, e.g., a material that generates heat responsive to flow of electrical current therethrough. In one configuration, the heating element comprises one or a plurality of electrically conductive filaments. The term ‘filament’ refers to an electrical path arranged between two electrical contacts. The heating element may be or include an array of filaments or wires, for example arranged parallel to each other. In some configurations, the filaments or wires may form a mesh. However, it should be appreciated that any suitable configuration and material of the heating element may be used.

For example, the heating element may include or be formed from any material with suitable electrical properties. Suitable materials include but are not limited to: semiconductors such as doped ceramics, electrically ‘conductive’ ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, constantan, nickel-, cobalt-, chromium-, aluminum-, titanium-, zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminum based alloys and iron-manganese-aluminum based alloys. Timetal® is a registered trade mark of Titanium Metals Corporation. Exemplary materials are stainless steel and graphite, more preferably 300 series stainless steel like AISI 304, 316, 304L, 316L. Optionally, the heating element may comprise combinations of the above materials. In one nonlimiting configuration, the heating element includes or is made of wire. More preferably, the wire is made of metal, most preferably made of stainless steel.

The heater assembly further may comprise electrical contact portions electrically connected to the heating element. The electrical contact portions may be or include two electrically conductive contact pads. In configurations including a housing, the contact portions may exposed through a connection end of the housing to allow for contact with electrical contact pins in an aerosol-generating device.

The reservoir may comprise a reservoir housing. The aerosol-generating element, a heating assembly comprising the aerosol-generating element, or any suitable component thereof may be fixed to the reservoir housing. The reservoir housing may comprise a moulded component or mount, the moulded component or mount being moulded over the aerosol-generating element or the heating assembly. The moulded component or mount may cover all or a portion of the aerosol-generating element or heating assembly and may partially or fully isolate electrical contact portions from one or both of the airflow path and the aerosol-forming substrate. The moulded component or mount may comprise at least one wall forming part of the reservoir housing. The moulded component or mount may define a flow path from the reservoir to the aerosol-generating element.

The housing may be formed form a mouldable plastics material, such as polypropylene (PP) or polyethylene terephthalate (PET). The housing may form a part or all of a wall of the reservoir. The housing and reservoir may be integrally formed. Alternatively the reservoir may be formed separately from the housing and assembled to the housing.

In configurations in which the aerosol-generating system includes a cartridge, the cartridge may comprise a removable mouthpiece through which aerosol may be drawn by a user. The removable mouthpiece may cover the mouth end opening. Alternatively the cartridge may be configured to allow a user to draw directly on the mouth end opening.

The cartridge may be refillable with liquid or gel aerosol-forming substrate. Alternatively, the cartridge may be designed to be disposed of when the reservoir becomes empty of liquid or gel aerosol-forming substrate.

In configurations in which the aerosol-generating system further includes an aerosol-generating device, the aerosol-generating device may comprise at least one electrical contact element configured to provide an electrical connection to the aerosol-generating element when the aerosol-generating device is connected to the cartridge. The electrical contact element optionally may be elongate. The electrical contact element optionally may be spring-loaded. The electrical contact element optionally may contact an electrical contact pad in the cartridge. Optionally, the aerosol-generating device may comprise a connecting portion for engagement with the connection end of the cartridge. Optionally, the aerosol-generating device may comprise a power supply. Optionally, the aerosol-generating device may comprise control circuitry configured to control a supply of power from the power supply to the aerosol-generating element.

The control circuitry optionally may comprise a microcontroller. The microcontroller is preferably a programmable microcontroller. The control circuitry may comprise further electronic components. The control circuitry may be configured to receive or transmit signals from and to the present interface elements, e.g., to receive signals from the present contact sensing elements and to transmit signals to the present light emitting elements. The control circuitry further may be configured to regulate a supply of power to the aerosol-generating element. Power may be supplied to the aerosol-generating element continuously following activation of the system or may be supplied intermittently, such as on a puff-by-puff basis. The power may be supplied to the aerosol-generating element in the form of pulses of electrical current.

The aerosol-generating device may comprise a power supply arranged to supply power to at least one of the control system, the interface element (e.g., one or both of the contact sensing element and the light emitting element), and the aerosol-generating element. The aerosol-generating element may comprise an independent power supply. The aerosol-generating device may comprise a first power supply arranged to supply power to the control circuitry, a second power supply configured to supply power to the aerosol-generating element, and a third power supply configured to supply power to the interface element, or may comprise fewer power supplies that respectively are configured to supply power to any suitable combination of the control circuitry, the aerosol-generating element, and the interface element.

Each such power supply may be or include a DC power supply. The power supply may be or include a battery. The battery may be or include a lithium based battery, for example a lithium-cobalt, a lithium-iron-phosphate, a lithium titanate or a lithium-polymer battery. The battery may be or include a nickel-metal hydride battery or a nickel cadmium battery. The power supply may be or include another form of charge storage device such as a capacitor. Optionally, the power supply may require recharging and be configured for many cycles of charge and discharge. The power supply may have a capacity that allows for the storage of enough energy for one or more user experiences; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the heating assembly. Preferably, the power supply further may have sufficient capacity to allow for any suitable number of uses of the contact sensing element and the light emitting element.

The aerosol-generating system may be or include a handheld aerosol-generating system. The handheld aerosol-generating system may be configured to allow a user to puff on a mouthpiece to draw an aerosol through the mouth end opening. The aerosol-generating system may have a size comparable to a conventional cigar or cigarette. The aerosol-generating system optionally may have a total length between about 30 mm and about 150 mm. The aerosol-generating system may have an external diameter between about 5 mm and about 30 mm.

Optionally, the housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material may be light and non-brittle. The contact sensing element may be coupled to any suitable portion of the housing as to detect contact by the user. The light emitting element may be coupled to any suitable portion of the housing as to transmit a visible light signal.

The cartridge or the aerosol-generating device of an aerosol-generating system may comprise a puff detector in communication with the control circuitry. The puff detector may be configured to detect when a user draws through the airflow path. The cartridge or aerosol-generating device optionally may comprise a temperature sensor in communication with the control circuitry. The cartridge or aerosol-generating device may comprise a user input, such as a switch or button, or the present interface element, e.g., the present contact sensing element. The user input may enable a user to turn the device on and off. The cartridge or aerosol-generating device optionally may comprise indication means for indicating the determined amount of aerosol-forming substrate held in the reservoir to a user. The control circuitry may be configured to activate the indication means after a determination of the amount of aerosol-forming substrate held in the reservoir has been made. The indication means optionally may comprise one or more of lights, such as light emitting diodes (LEDs), a display, such as an LCD display and audible indication means, such as a loudspeaker or buzzer and vibrating means. The control circuitry may be configured to light one or more of the lights, display an amount on the display, emit sounds via the loudspeaker or buzzer and vibrate the vibrating means. The indication means may include, or be, the present interface element, e.g., the present light emitting element.

Preferably, the control circuitry is configured to actuate the present interface element, e.g., the present light emitting element, so as to convey suitable information to the user. Optionally, the control circuitry is configured to actuate the light emitting element responsive to detecting contact by the contact sensing element.

The aerosol-forming substrate may have any suitable composition. For example, the aerosol-forming substrate may comprise nicotine. The nicotine containing aerosol-forming substrate may be or include a nicotine salt matrix. The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may comprise homogenised tobacco material. The aerosol-forming substrate may comprise a non-tobacco-containing material. The aerosol-forming substrate may comprise homogenised plant-based material.

The aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The aerosol-forming substrate may comprise water, solvents, ethanol, plant extracts and natural or artificial flavours. The aerosol-forming substrate may comprise nicotine and at least one aerosol former. The aerosol former may be glycerine or propylene glycol. The aerosol former may comprise both glycerine and propylene glycol. The aerosol-forming substrate may have a nicotine concentration of between about 0.5% and about 10%, for example about 2%.

It should be appreciated that the present interface elements, e.g., the present contact sensing elements and light emitting elements, are not limited to use with aerosol-generating systems or aerosol-generating devices configured for use with liquid or gel aerosol-forming substrates. For example, in other configurations the present interface elements may be used with or included in aerosol-generating systems or aerosol-generating devices that are configured for use with a solid aerosol-forming substrate. One type of aerosol-generating element that may be used with a solid-aerosol forming substrate includes a heater configured to be inserted into a solid aerosol-forming substrate, such as a plug of tobacco.

In some configurations, the heater is substantially blade-shaped for insertion into the aerosol-forming substrate and optionally has a length of between 10 mm and 60 mm, a width of between 2 mm and 10 mm, and a thickness of between 0.2 mm and 1 mm. A preferred length may be between 15 mm and 50 mm, for example between 18 mm and 30 mm. A preferred length may be about 19 mm or about 20 mm. A preferred width may be between 3 mm and 7 mm, for example between 4 mm and 6 mm. A preferred width may be about 5 mm. A preferred thickness may be between 0.25 mm and 0.5 mm. A preferred thickness may be about 0.4 mm. The heater may include an electrically-insulating heater substrate and an electrically-resistive heating element supported by the heater substrate. A through-hole optionally may be defined through the thickness of the heater. The heater mount may provide structural support to the heater and may allow the heater to be located within the aerosol-generating device. The heater mount optionally may be formed from a mouldable material that is moulded around a portion of the heater and may extend through the though-hole to couple to the heater to the heater mount. The heater optionally may have a tapered or pointed end to facilitate insertion into an aerosol-forming substrate.

The heater mount is preferably moulded to a portion of the heater that does not significantly increase in temperature during operation. Such a portion may be termed a holding portion and the heating element may have lower resistivity at this portion so that it does not heat up to a significant degree on the passage of an operational current. The through-hole may be located in the holding portion. The through-hole, if provided, may be formed in the heater before or after the electrically-resistive heating element is formed on the heater substrate. A device may be formed by fixing or coupling a heating assembly to, or within, a housing. The through-hole may be formed by machining, for example by laser machining or by drilling.

The heater mount may provide structural support to the heater and allows it to be securely fixed within an aerosol-generating device. The use of a mouldable material such as a mouldable polymer allows the heater mount to be moulded around the heater and thereby firmly hold the heater. It also allows the heater mount to be produced with a desired external shape and dimensions in an inexpensive manner.

Advantageously, the heating element may be formed from different materials. A first part, or heating part, of the heating element (i.e. that portion supported by the insertion or heating portion of the heater) may be formed from a first material and a holding part of the heating element (i.e. that part supported by a holding portion of the heater) may be formed from a second material, wherein the first material has a greater electrical resistivity coefficient than the second material. For example, the first material may be Ni—Cr (Nickel-Chromium), platinum, tungsten or alloy wire and the second material may be gold or silver or copper. The dimensions of the first and second parts of the heating element may also differ to provide for a lower electrical resistance per unit length in the second portion.

The heater substrate is formed from an electrically insulating material and may be a ceramic material such as Zirconia or Alumina. The heater substrate may provide a mechanically stable support for the heating element over a wide range of temperatures and may provide a rigid structure suitable for insertion into an aerosol-forming substrate. The heater substrate comprises a planar surface on which the heating element is positioned and may comprise a tapered end configured to allow for insertion into an aerosol-forming substrate. The heater substrate advantageously has a thermal conductivity of less than or equal to 2 Watts per metre Kelvin.

The aerosol-generating device preferably comprises a housing defining a cavity surrounding an insertion portion of the heater. The cavity is configured to receive an aerosol-forming article containing an aerosol-forming substrate. The heater mount may form a surface closing one end of the cavity.

In some configurations, the device is preferably a portable or handheld device that is comfortable to hold between the fingers of a single hand.

The power supply of the device may be any suitable power supply, for example a DC voltage source such as a battery. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery.

The aerosol-generating device preferably comprises a control element. The control element may be a simple switch. Alternatively the control element may be electric circuitry and may comprise one or more microprocessors or microcontrollers, which may be configured to control the heater as well as the present interface element, e.g., the present contact sensing element and light emitting element.

The disclosure provides an aerosol-generating system comprising an aerosol-generating device as described herein and one or more aerosol-forming articles configured to be received in a cavity of the aerosol-generating device. The aerosol-generating device can include the present interface element, or the interface element may be part of another component of the aerosol-generating system, such as a peripheral device.

During a usage session, an aerosol-generating article containing the aerosol-forming substrate may be partially contained within the aerosol-generating device. The aerosol-generating article may be substantially cylindrical in shape. The aerosol-generating article may be substantially elongate. The aerosol-generating article may have a length and a circumference substantially perpendicular to the length. The aerosol-forming substrate may be substantially cylindrical in shape. The aerosol-forming substrate may be substantially elongate. The aerosol-forming substrate may also have a length and a circumference substantially perpendicular to the length. The aerosol-generating article may have a total length between approximately 30 mm and approximately 100 mm. The aerosol-generating article may have an external diameter between approximately 5 mm and approximately 12 mm.

The solid aerosol-forming substrate may comprise a tobacco-containing material containing volatile tobacco flavour compounds which are released from the substrate upon heating. Alternatively, the solid aerosol-forming substrate may comprise a non-tobacco material. The solid aerosol-forming substrate may further comprise an aerosol former that facilitates the formation of a dense and stable aerosol. Examples of suitable aerosol formers are glycerine and propylene glycol.

The solid aerosol-forming substrate may comprise, for example, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco, cast leaf tobacco and expanded tobacco. The solid aerosol-forming substrate may be in loose form, or may be provided in a suitable container or cartridge. Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

As used herein, homogenised tobacco refers to material formed by agglomerating particulate tobacco. Homogenised tobacco may be in the form of a sheet. Homogenised tobacco material may have an aerosol-former content of greater than 5% on a dry weight basis. Homogenised tobacco material may alternatively have an aerosol former content of between 5% and 30% by weight on a dry weight basis. Sheets of homogenised tobacco material may be formed by agglomerating particulate tobacco obtained by grinding or otherwise combining one or both of tobacco leaf lamina and tobacco leaf stems. Alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof.

Optionally, the solid aerosol-forming substrate may be provided on or embedded in a thermally stable carrier. The carrier may take the form of powder, granules, pellets, shreds, spaghettis, strips or sheets. Alternatively, the carrier may be a tubular carrier having a thin layer of the solid substrate deposited on its inner surface, or on its outer surface, or on both its inner and outer surfaces. Such a tubular carrier may be formed of, for example, a paper, or paper like material, a non-woven carbon fibre mat, a low mass open mesh metallic screen, or a perforated metallic foil or any other thermally stable polymer matrix.

In some configurations, the aerosol-forming substrate comprises a gathered crimpled sheet of homogenised tobacco material. As used herein, the term ‘crimped sheet’ denotes a sheet having a plurality of substantially parallel ridges or corrugations. Preferably, when the aerosol-generating article has been assembled, the substantially parallel ridges or corrugations extend along or parallel to the longitudinal axis of the aerosol-generating article. This advantageously facilitates gathering of the crimped sheet of homogenised tobacco material to form the aerosol-forming substrate. However, it will be appreciated that crimped sheets of homogenised tobacco material for inclusion in the aerosol-generating article may alternatively or in addition have a plurality of substantially parallel ridges or corrugations that are disposed at an acute or obtuse angle to the longitudinal axis of the aerosol-generating article when the aerosol-generating article has been assembled. In certain embodiments, the aerosol-forming substrate may comprise a gathered sheet of homogenised tobacco material that is substantially evenly textured over substantially its entire surface. For example, the aerosol-forming substrate may comprise a gathered crimped sheet of homogenised tobacco material comprising a plurality of substantially parallel ridges or corrugations that are substantially evenly spaced-apart across the width of the sheet.

The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

It should be appreciated that although certain configurations described herein include aerosol-generating elements that generate aerosols via resistive heating, any suitable aerosol-generating element may be used, for example an inductive heating arrangement.

A method of making an aerosol-generating system may comprise providing a housing comprising an upper surface, a lower surface, and an at least partially transparent region extending between the upper surface and the lower surface. The method may comprise providing an interface element. The interface element may comprise a contact sensing element and a light emitting element. The contact sensing element may be configured to generate an input signal responsive to the contact sensing element detecting contact with the upper surface. The light emitting element may be configured so as to transmit a first visible light signal through the at least partially transparent region responsive to a first output signal. The method may comprise coupling a circuit to the contact sensing element and the light emitting element. The circuit may be configured to receive the input signal from the contact sensing element and to transmit the first output signal to the light emitting element.

For example, a method of making an aerosol-generating system may comprise providing a housing comprising an upper surface, a lower surface, and an at least partially transparent region extending between the upper surface and the lower surface. The method comprises providing an interface element. The interface element may comprise a contact sensing element and a light emitting element. The contact sensing element is configured to generate an input signal responsive to the contact sensing element detecting contact with the upper surface. The light emitting element is configured so as to transmit a first visible light signal through the at least partially transparent region responsive to a first output signal. The method comprises coupling a circuit to the contact sensing element and the light emitting element. The circuit is configured to receive the input signal from the contact sensing element and to transmit the first output signal to the light emitting element.

Optionally, the method further comprises forming a recess in a portion of the housing to form the at least partially transparent region. Optionally, forming the recessed portion of the housing comprises laser eroding the portion of the housing. Laser eroding the portion of the housing may be performed with a standard, industrial laser eroding machine.

A method of using an aerosol-generating system may comprise generating, by an interface element comprising a plurality of contact sensing elements, a plurality of input signals responsive to detecting contact with an upper surface of a housing at or near respective regions of the housing. The method may comprise receiving, by a circuit, the plurality of input signals. The method may comprise enabling, by the circuit, a function of the aerosol-generating system responsive to the plurality of input signals satisfying a criterion.

For example, a method of using an aerosol-generating system may comprise generating, by an interface element comprising a plurality of contact sensing elements, a plurality of input signals responsive to detecting contact with an upper surface of a housing at or near respective regions of the housing. The method comprises receiving, by a circuit, the plurality of input signals. The method comprises enabling, by the circuit, a function of the aerosol-generating system responsive to the plurality of input signals satisfying a criterion.

Features described in relation to any embodiment or configuration of the invention may be applied to other embodiments or configurations of the invention.

Features described in relation to an aerosol-generating system according to an embodiment or configuration of the invention may be applied to an aerosol-generating system according to another embodiment or configuration of the invention.

Features described in relation to an aerosol-generating system may be applied to a method of making an aerosol-generating system. Features described in relation to a method of making an aerosol-generating system may be applied to an aerosol-generating system.

Features described in relation to an aerosol-generating system may be applied to a method of using an aerosol-generating system. Features described in relation to a method of using an aerosol-generating system may be applied to an aerosol-generating system.

Features described in relation to a method of making an aerosol-generating system may be applied to a method of using an aerosol-generating system. Features described in relation to a method of using an aerosol-generating system may be applied to a method of making an aerosol-generating system.

Configurations of the invention will now be described in detail, by way of example only, with reference to the accompanying drawings, in which:

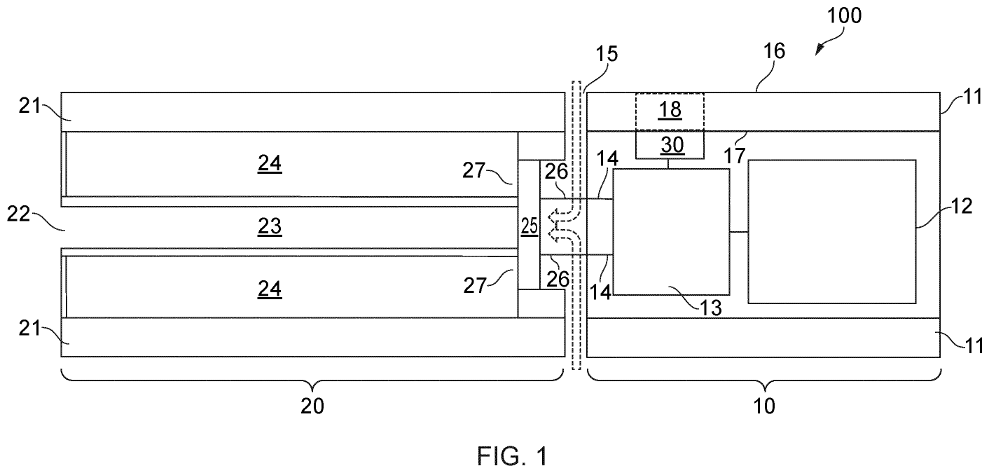

FIG. 1 is a schematic illustration of a cross-section of an aerosol-generating system including an interface element in accordance with the invention;

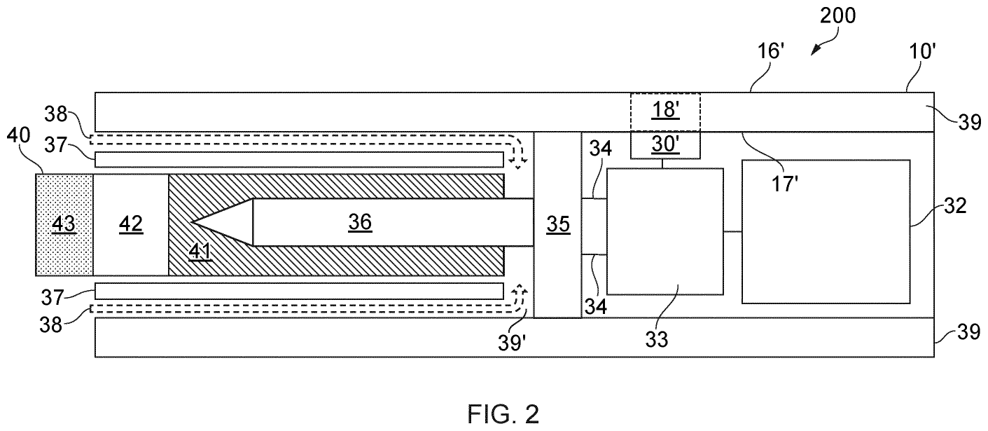

FIG. 2 is a schematic illustration of a cross-section of another aerosol-generating system including an interface element in accordance with the invention;

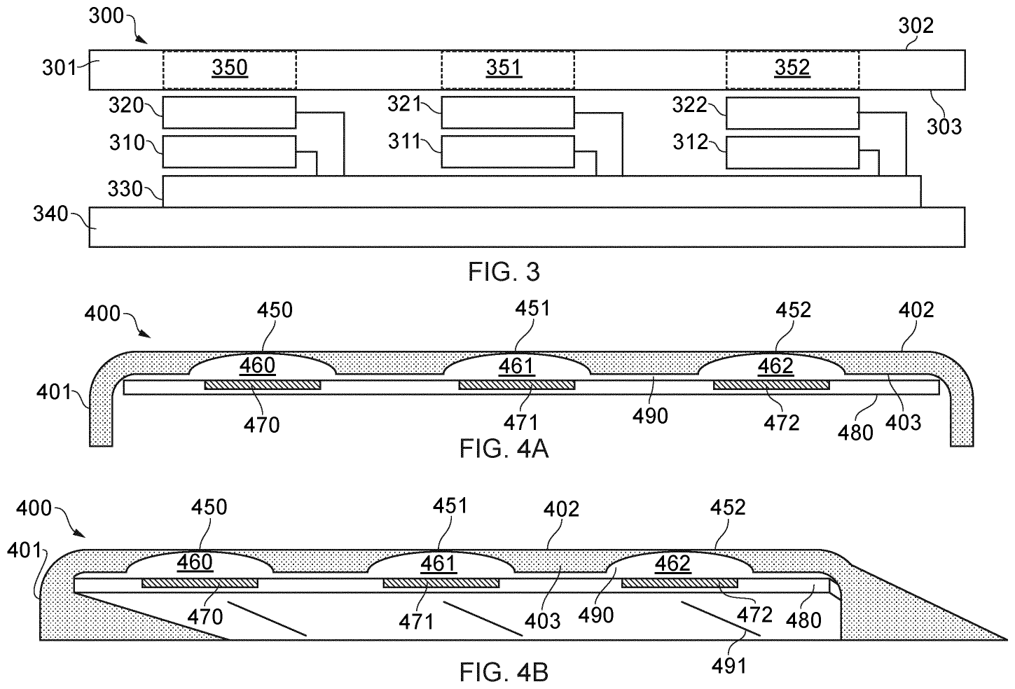

FIG. 3 is a schematic illustration of a cross-section of an exemplary interface element, in accordance with the invention;

FIGS. 4A-4B respectively schematically illustrate a cross-section and a perspective view of another exemplary interface element in accordance with the invention;

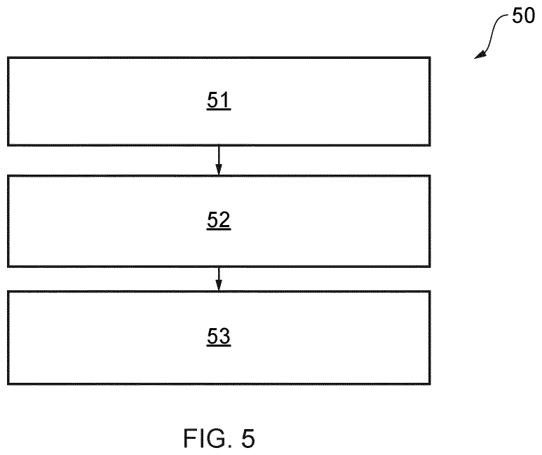

FIG. 5 illustrates a flow of operations in an exemplary method, in accordance with the invention;

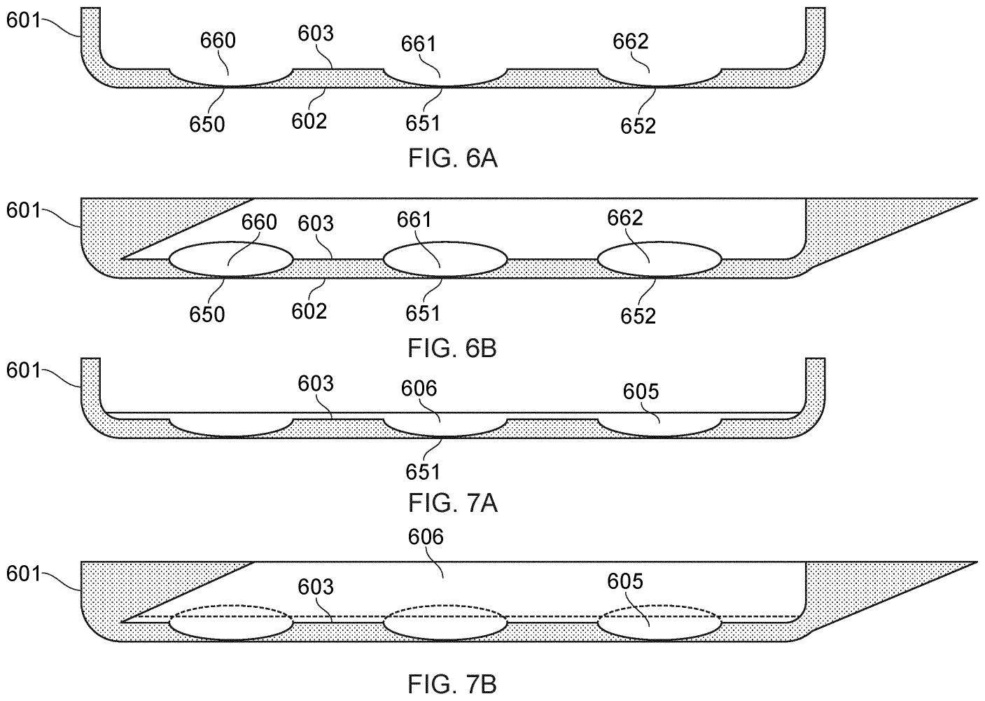

FIGS. 6A-6B respectively schematically illustrate a cross-section and a perspective view of an intermediate structure formed during the flow of operations of FIG. 5 in accordance with the invention;

FIGS. 7A-7B respectively schematically illustrate a cross-section and a perspective view of another intermediate structure formed during the flow of operations of FIG. 5 in accordance with the invention;

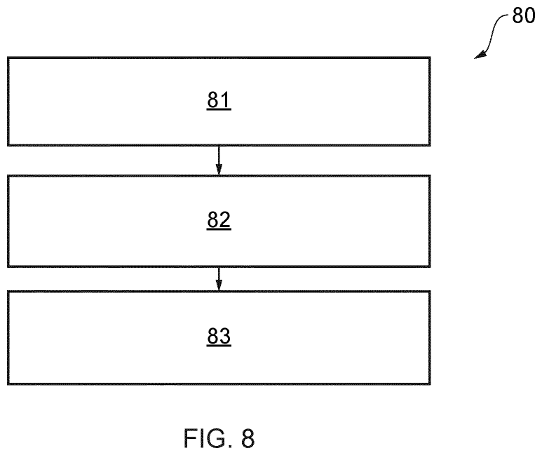

FIG. 8 illustrates a flow of operations in another exemplary method, in accordance with the invention;

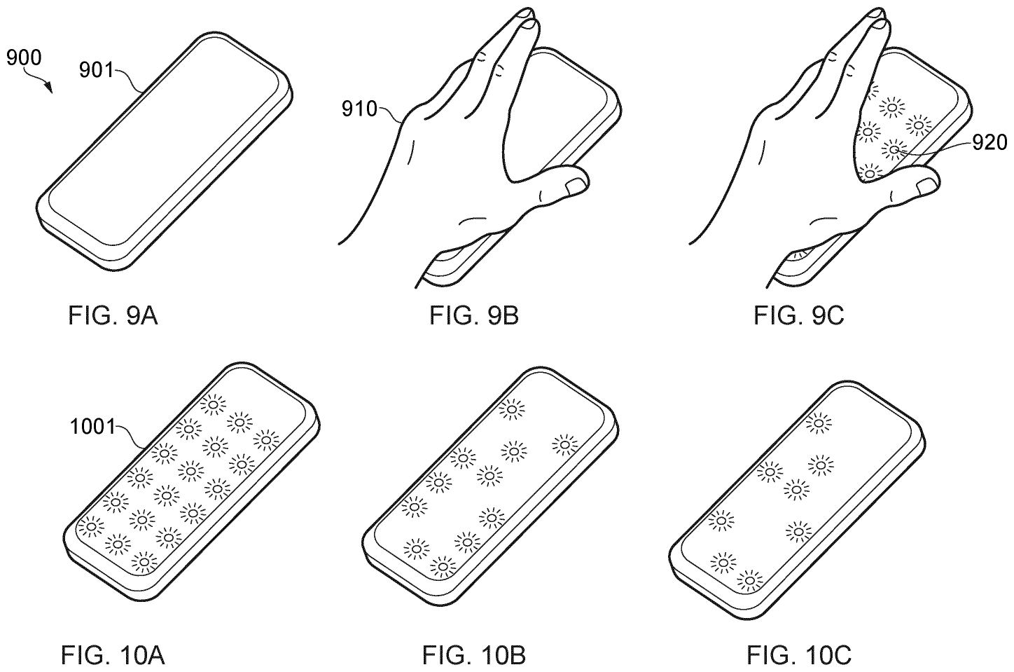

FIGS. 9A-9C are schematic illustrations of exemplary uses of the present interface element in accordance with the invention; and

FIGS. 10A-10C are schematic illustrations of additional or alternative exemplary uses of the present interface element in accordance with the invention.

Configurations provided herein relate to an improved interface element for an aerosol-generating system. The present interface element preferably includes one or a plurality of contact sensing elements. The one or plurality of sensing elements are configured for detecting contact with a housing of the aerosol-generating system. Optionally, the interface element may further include one or a plurality of light emitting elements that transmit light through the housing of the aerosol-generating system. The interface element may be coupled to the aerosol-generating system in such a manner that the housing has a smooth and contiguous outer (upper) surface. Such a smooth or contiguous outer surface may provide a more ergonomic device or may be appealing to a user. In some embodiments, the interface element may be configured to authenticate users and to inhibit or prevent unauthorized users from using the aerosol-generating system. The light emitting element(s), if included, may emit one or more different wavelengths than one another, which the user may perceive as different colours than one another. In configurations that include light emitting element(s), such wavelengths optionally may be used to communicate information to a user or may be used as part of an authentication process. Optionally, the housing does not include any mechanical button(s). Other types of conventional input elements, such as biometric sensors or touch screens, may be omitted from the aerosol-generating system. For example, the interface element optionally may be provided as the system's sole means to provide information to and transmit information from the aerosol-generating system for use of the system. As such, potential modes of failure may be reduced or eliminated. Costs of producing the aerosol-generating system may be reduced. The user experience may be simplified. As such, user experience and system cost and management may be improved.

The present interface element may be used in any suitable aerosol-generating system or component thereof. For example, FIG. 1 is a schematic illustration of an aerosol-generating system 100 comprising an interface element 30 in accordance with the invention. The system 100 comprises an aerosol-generating article 20 comprising an aerosol-forming substrate, and an aerosol-generating device 10. In the embodiment illustrated in FIG. 1, the aerosol-generating article is provided in the form of a cartridge 20 comprising one or both of a liquid and a gel aerosol-forming substrate. In other embodiments, the aerosol-forming substrate may be a solid aerosol-forming substrate, for example such as described with reference to FIG. 2.

In the embodiment illustrated in FIG. 1, a connection end of the cartridge 20 is removably connectable to a corresponding connection end of the aerosol-generating device 10. The aerosol-generating device 10 includes housing 11, which includes upper surface 16, lower surface 17, and at least one region 18. Optionally, the upper surface 16 of housing 11 is substantially flat over region 18. Optionally, housing 11 may be button-free, that is, may not include any buttons. Optionally, the upper surface 16 of housing 11 may be substantially smooth and contiguous. It should be understood that housing 11 may be, but need not necessarily be, considered to be part of the present interface element. Disposed within housing 11 is a battery 12, which in one example is a rechargeable lithium ion battery, control circuitry 13, and interface element 30 coupled to control circuitry 13 via an electrical interconnect. The aerosol-generating system 100 is portable and may have a size comparable to a conventional cigar or cigarette. For example, system 100 preferably is sized and shaped so as to be handheld, and preferably sized and shaped so as to be holdable in one hand, e.g., between a user's fingers.

The cartridge 20 comprises a housing 21 containing a heating assembly 25 and a reservoir 24. A liquid or gel aerosol-forming substrate is held in the reservoir 24. The upper portion of reservoir 24 is connected to the lower portion of the reservoir 24 illustrated in FIG. 1. The heating assembly 25 receives substrate from reservoir 24 and heats the substrate to generate a vapour, e.g., includes a resistive heating element coupled to controller 13 via electrical interconnects 26, 14 so as to receive power from battery 12. One side of heating assembly 25 is in fluidic communication with reservoir 24 (for example, via fluidic channels 27) so as to receive the aerosol-forming substrate from reservoir 24, e.g., by capillary action. The heating assembly 25 is configured to heat the aerosol-forming substrate to generate a vapour.

In the illustrated configuration, an air flow path 23 extends through the cartridge 20 from air inlet 15 (optionally which may be between aerosol-generating device 10 and cartridge 20), past the heating assembly 25, and through a path 23 through reservoir 24 to a mouth end opening 22 in the cartridge housing 21. The system 100 is configured so that a user may puff on the mouth end opening 22 of the cartridge 20 to draw aerosol into their mouth. In operation, when a user puffs on the mouth end opening 22, air is drawn into and through the airflow path 23 from the air inlet 15 and past the heating assembly 25 as illustrated in dashed arrows in FIG. 1, and to the mouth end opening 22. The control circuitry 13 controls the supply of electrical power from the battery 12 to the cartridge 20 via electrical interconnects 14 (in aerosol-generating device 10) coupled to electrical interconnects 26 (in cartridge 20) when the system is activated. This in turn controls the amount and properties of the vapour produced by the heating assembly 25. The control circuitry 13 may include an airflow sensor (not specifically illustrated) and the control circuitry may 13 supply electrical power to the heating assembly 25 when the user puffs on the cartridge 20 as detected by the airflow sensor. This type of control arrangement is well established in aerosol-generating systems such as inhalers and e-cigarettes. When a user puffs on the mouth end opening 22 of the cartridge 20, the heating assembly 25 is activated and generates a vapour that is entrained in the air flow passing through the air flow path 23. Optionally, the vapour at least partially cools within the airflow path 23 to form an aerosol within the airflow path, which is then drawn into the user's mouth through the mouth end opening 22. In some configurations, the vapour at least partially cools within the user's mouth to form an aerosol within the user's mouth.

Interface element 30 illustrated in FIG. 1 is coupled to housing 11 and configured so as to detect contact with the upper surface 16 of housing 11, e.g., contact between the skin of the user and upper surface 16. For example, interface element 30 may include one or more contact sensing elements, each disposed between the lower surface 17 of the housing. Interface element 30 optionally may include a printed circuit board (PCB), which may be flexible, and which may include the circuit, the contact sensing element(s), and any light emitting element(s). Exemplary configurations for interface element 30 are provided herein with reference to FIGS. 3 and 4A-4B, but it should be understood that the present interface element is not so limited, and may have any suitable configuration.

Each of the one or more contact sensing elements is configured to generate a respective input signal responsive to detecting contact with the upper surface 16. For example, the upper surface 16 of housing 11 may include one or more regions, such as within region 18 illustrated in FIG. 1. Contact with the upper surface 16 at or near region 18 may actuate the contact sensing element to generate an input signal. For example, the contact sensing element(s) may include a capacitive sensor, a pressure sensor, or a heat sensing element that generates the input signal responsive to contact that is sufficiently close to region 18 as to be detectable.

For example, a capacitive sensor may generate an input signal corresponding to a capacitance of the capacitive sensor. Prior to contact with any suitable body part of a user, e.g., a finger, palm, or lip of a user, the capacitive sensor may have a first capacitance, responsive to which the capacitive sensor may output a signal having a value corresponding to an absence of such contact. Responsive to contact with the suitable body part of the user, who is touching the upper surface 16 of housing 11 with that body part, e.g., at a region sufficiently close to the capacitive sensor, the capacitance of the capacitive sensor may increase or decrease to a second value, causing the value of the signal generated by the capacitive sensor to change correspondingly. Based on such changes in the value of the signal that the capacitive sensor generates, an appropriate circuit may determine that there is contact with the upper surface 16 of housing 11.

As another example, a pressure sensor may generate an input signal corresponding to a pressure of the pressure sensor. Prior to contact with a finger, palm, or lip of a user, the pressure sensor may have a first pressure, responsive to which the pressure sensor may output a signal having a value corresponding to an absence of such contact. Responsive to contact with the finger, palm, or lip of a user who is touching the upper surface 16 of housing 11, e.g., at a region sufficiently close to the pressure sensor, the pressure of the pressure sensor may increase to a second value, causing the value of the signal generated by the pressure sensor to change correspondingly. Based on such changes in the value of the signal that the pressure sensor generates, an appropriate circuit may determine that there is contact with the upper surface 16 of housing 11.

As still another example, a heat sensing element may generate an input signal corresponding to a temperature of the heat sensing element. Prior to contact with a finger, palm, or lip of a user, the heat sensing element may have a first temperature, e.g., ambient (room) temperature, or a temperature that is different than ambient because of heat transferred from the aerosol-generating element, responsive to which the heat sensing element may output a signal having a value corresponding to such temperature. Responsive to contact with the finger, palm, or lip of a user who is touching the upper surface 16 of housing 11, e.g., at a region sufficiently close to the heat sensing element as to be in thermal communication with the heat sensing element via housing 11, the temperature of the heat sensing element may increase or decrease to a second temperature, causing the value of the signal generated by the heat sensing element to change correspondingly. Based on such changes in the value of the signal that the heat sensing element generates, an appropriate circuit may determine that there is contact with the upper surface 16 of housing 11.

The system 100 may include any suitable circuit configured to receive the input signal from the contact sensing element. In some configurations, interface element 30 may include a separate, dedicated circuit that is so configured, while in other configurations control circuitry 13 is so configured. The circuit may be configured so as to generate one or more signals, such as described elsewhere herein, responsive to receiving the respective input signal from each of the one or more contact sensing elements. Illustratively, the circuit may be configured so as to transmit an output signal to an optional light emitting element, or may be configured so as to enable a function of the aerosol-generating system, or any suitable combination thereof. For example, enabling a function of the aerosol-generating system may include transmitting an output signal to a light emitting element. Exemplary functions of the circuit, which may but need not necessarily include transmitting signals to any light emitting elements, are described with reference to FIGS. 8, 9A-9C, and 10A-10C.

In some configurations, interface element 30 optionally may include one or more light emitting elements, such as one or more light emitting diodes (LEDs) or organic light emitting diodes (OLEDs) or active-matrix organic light emitting diodes (AMOLEDs) or plastic organic light emitting diodes (POLEDs) or quantum-dot light-emitting diodes (QLEDs) or microscopic light emitting diodes (micro-LEDs). Optionally, such light emitting element(s) may be configured to transmit one or more visible light signals through the housing 11, for example responsive to respective output signal(s) which may be generated by the same circuit that receives the input signal(s) from the contact sensing element(s). For example, region 18 of housing 11 may be at least partially transparent such that the light emitting element(s) may transmit a visible light signal therethrough. Illustratively, region 18 may include a recessed portion of housing 11 that is sufficiently thin that a visible light signal may be transmitted therethrough.

Optionally, a material may be disposed in the recessed portion that is configured to change an optical property of the visible light signal generated by one or more of the light emitting element(s). For example, the material may change a focal property of the visible light signal, such as focusing or defocusing the visible light signal. The material may be shaped so as to focus or defocus the visible light signal. For example, the material may have a convex shape, or a concave shape, and this shape of the material may act to focus or defocus the visible light signal. Advantageously, focusing or defocusing the visible light signal may allow detection of a visible light signal with less energy. This may allow the light emitting element to consume less power when transmitting the visible light signal. The material may be shaped prior to being disposed in the recessed portion.

The recessed portion may be filled with the material. The material may, thus, be shaped by the shape of the recessed portion. Optionally, the recessed portion may be shaped forming a shaped recessed portion. The shaped recessed portion may be filled with the material. The material may thus take on a shape corresponding to that of the shaped recessed portion. Thus, a recessed portion having a concave internal shape may be filled with a material, that material then having a convex shape corresponding to the concave shape of the recessed portion. The material may comprise a smart material which acts to focus, or defocus, the visible light signal.

The material may comprise a transparent or translucent polymeric material. For example, the material may comprise one or more of a transparent or translucent compound of Polymethylmethacrylate (PMMA), Polyethylene Terephthalate (PET), Polyethylene Terephthalate Glycol (PETG), Polyvinyl chloride (PVC), Polypropylene (PP), Poly[2-(dimethylamino)ethyl methacrylate] (often abbreviated to PDM or PDMAEMA), Styrene Acrylonitrile Resin (SAN), General Purpose Polystyrene (GPPS), Liquid Silicone Rubber (LSR), Cyclic Olefin Copolymer (COC), and Styrene Methyl Methacrylate (SMMA).

The material may be moulded. The material may be over-moulded. The material may be 3D printed.

Alternatively, the entire housing 11 may include or may be formed of an at least partially transparent material. As still another alternative, housing 11 may include an opaque material surrounding into which is integrated an least partially transparent window which define regions 18. Regardless of the particular configuration, optionally the regions 18 are not immediately obvious to a user in the normal state of the device.

Each of the light emitting element(s) optionally may be configured so as to generate first and second visible light signals through the at least partially transparent region 18 of housing 11 that have different wavelengths than one another. For example, the circuit may be configured to generate first and second output signals (optionally at different times than one another) that respectively cause the light emitting element(s) to generate the first and second visible light signals that have different wavelengths than one another (optionally at different times than one another). The wavelengths may differ from one another by an amount sufficient as to be perceived by the human eye, e.g., may differ from each other by at least 1 nm, or by at least 5 nm, or by at least 10 nm, or by at least 20 nm, or by at least 50 nm, or by at least 100 nm, or by at least 200 nm, or by at least 300 nm.

It should be appreciated that interface element 30 may be located at any suitable portion of aerosol-generating system 100 and is not limited to detecting contact only with an outer portion of housing 11 or other portion of aerosol-generating device 10. For example, interface element 30 may be located at any suitable location of aerosol-generating device 10 or cartridge 20, e.g., may be coupled to any suitable portion of housing 11 or housing 21 so as to detect contact with any suitable outer portion of system 100, e.g., any suitable portion of system 100 that may be touched by the user's body part, such as lip, finger, or palm, during use.

In some configurations, aerosol-generating system 100 comprises an aerosol-generating device which may include interface element 30, or which may not include interface element 30, and a peripheral device in operable communication with the aerosol-generating device (peripheral device not specifically illustrated in FIG. 1). The peripheral device optionally includes interface element 30, in addition to or instead of the aerosol-generating device including interface element 30. In nonlimiting configurations, the peripheral device optionally comprises a device charger, charging case, consumable holder, or vending machine.

In some configurations, an aerosol-generating system comprises an aerosol-generating device such as described herein and an aerosol-forming substrate, optionally wherein the aerosol-forming substrate comprises nicotine.

FIG. 2 is a schematic illustration of an alternative aerosol-generating system 200 including interface element 30′ in accordance with the invention. Interface element 30′ may include a contact sensing element and an optional light emitting element, and may be configured similarly as interface element 30 described with reference to FIG. 1. The system 200 comprises an aerosol-generating device 10′ having a housing 39, and an aerosol-forming article 40, for example a tobacco stick. The aerosol-forming article 40 includes an aerosol-forming substrate 41 that is pushed inside the housing 39 to come into thermal proximity with a portion of a heater 36. Responsive to heating by heater 36, the aerosol-forming substrate 41 will release a range of volatile compounds at different temperatures.

Housing 39 includes upper surface 16′, lower surface 17′, and at least one region 18′. Optionally, the upper surface 16′ of housing 39 is substantially flat over region 18′. Housing 39 optionally may be button-free, that is, may not include any buttons. The upper surface 16′ of housing 39 optionally may be substantially smooth and contiguous. Within the housing 39 there is an electrical energy supply 32, for example a rechargeable lithium ion battery. A controller 33 is connected to the heater 36 via electrical interconnects 34, to the electrical energy supply 32, and to interface element 30′ via an electrical interconnect. The controller 33 controls the power supplied to the heater 36 in order to regulate its temperature, and actuates interface element 30′ in a manner such as described elsewhere herein. Typically the aerosol-forming substrate is heated to a temperature of between 250 and 450 degrees centigrade.

The housing 39 of aerosol-generating device 10′ defines a cavity 39′, open at the proximal end (or mouth end), for receiving an aerosol-generating article 40 for consumption. Optionally, system 200 includes element(s) 37 disposed within the cavity 39′ which, together with housing 39, form(s) air inlet channels 38. The distal end of the cavity 39′ is spanned by a heating assembly comprising heater 36 and a heater mount 35. The heater 36 is retained by the heater mount 35 such that an active heating area (heating portion) of the heater 36 is located within the cavity 39′. In one example, the heater 36 includes a through hole (not specifically illustrated) through which material of heater mount 35 extends so as to further secure heater 36 in place. The active heating area of the heater 36 is positioned within a distal end of the aerosol-generating article 40 when the aerosol-generating article 40 is fully received within the cavity. The heater mount 35 optionally may be formed from polyether ether ketone and may be moulded around a holding portion of the heater. The heater 36 optionally is shaped in the form of a blade terminating in a point. That is, the heater 36 optionally has a length dimension that is greater than its width dimension, which is greater than its thickness dimension. First and second faces of the heater 36 may be defined by the width and length of the heater.

An exemplary aerosol-forming article 40, as illustrated in FIG. 2, may be described as follows. The aerosol-generating article 40 comprises three or more elements: an aerosol-forming substrate 41, an intermediate element 42, and a mouthpiece filter 43. These elements may be arranged sequentially and in coaxial alignment and assembled by a cigarette paper (not specifically illustrated) to form a rod. In one nonlimiting configuration, when assembled, the aerosol-forming article 40 may be 45 millimetres long and have a diameter of 7 millimetres, although it should be appreciated that any other suitable combination of dimensions may be used.

The aerosol-forming substrate 41 optionally comprises a bundle of crimped cast-leaf tobacco wrapped in a filter paper (not shown) to form a plug. The cast-leaf tobacco includes one or more aerosol formers, such as glycerine. The intermediate element 42 may be located immediately adjacent the aerosol-forming substrate 41. The intermediate element 42 may be configured so as to locate the aerosol-forming substrate 41 towards the distal end of the article 40 so that it may be contacted with the heater 36. Optionally, the intermediate element 42 may be configured so as to inhibit or prevent the aerosol-forming substrate 41 from being forced along the article 40 towards the mouthpiece when heater 36 is inserted into the aerosol-forming substrate 41. The intermediate element 42 optionally may be configured so as to allow volatile substances released from the aerosol-forming substrate 41 to pass along the article towards the mouthpiece filter 43. The volatile substances may cool within the transfer section to form an aerosol. In one nonlimiting configuration, intermediate element 42 may include or may be formed from a tube of cellulose acetate directly coupled to the aerosol-forming substrate. In one nonlimiting configuration, the tube defines an aperture having a diameter of 3 millimetres. Optionally, intermediate element 42 may include or be formed from a thin-walled tube of 18 millimetres in length directly coupled to the mouthpiece filter 43. In one exemplary configuration, intermediate element 42 includes both such tubes. The mouthpiece filter 43 may be a conventional mouthpiece filter, e.g., formed from cellulose acetate, and having a length of approximately 7.5 millimetres. Elements 41, 42, and 43 optionally are assembled by being tightly wrapped within a cigarette paper (not specifically illustrated), e.g., a standard (conventional) cigarette paper having standard properties or classification. The paper in this specific embodiment is a conventional cigarette paper. The interface between the paper and each of the elements 41, 42, 43 locates the elements and defines the aerosol-forming article 40.

As the aerosol-generating article 40 is pushed into the cavity 39′, the tapered point of the heater 36 engages with the aerosol-forming substrate 41. By applying a force to the aerosol-forming article 40, the heater 36 penetrates into the aerosol-forming substrate 41. When the aerosol-forming article 40 is properly engaged, the heater 36 is inserted into the aerosol-forming substrate 42. When the heater 36 is actuated, the aerosol-forming substrate 41 is warmed and volatile substances are generated or evolved. As a user draws on the mouthpiece filter 43, air is drawn into the aerosol-forming article 40 via air inlet channels 38 and the volatile substances condense to form an inhalable aerosol. This aerosol passes through the mouthpiece filter 43 of the aerosol-forming article 40 and into the user's mouth.

Similarly as described with reference to FIG. 1, it should be appreciated that interface element 30′ may be located at any suitable portion of aerosol-generating system 200 and is not limited to detecting contact only with an outer portion of housing 39 or other portion of aerosol-generating device 10′. For example, interface element 30′ may be located at any suitable location of aerosol-generating device 10′ or aerosol-forming article 40, e.g., may be coupled to any suitable portion of housing 39 so as to detect contact with any suitable outer portion of system 200, e.g., any suitable portion of system 200 that may be touched by the user's body part, such as lip, finger, or palm, during use.

In some configurations, aerosol-generating system 200 comprises an aerosol-generating device which may include interface element 30′, or which may not include interface element 30′, and a peripheral device in operable communication with the aerosol-generating device (peripheral device not specifically illustrated in FIG. 2). The peripheral device optionally includes interface element 30′, in addition to or instead of the aerosol-generating device including interface element 30′. In nonlimiting configurations, the peripheral device optionally comprises a device charger, charging case, consumable holder, or vending machine.

Further exemplary configurations of the present interface elements are described with reference to FIGS. 3 and 4A-4B. Exemplary methods of making aerosol-generating systems including the present interface elements are described with reference to FIGS. 5, 6A-6B, and 7A-7B. Exemplary methods of using aerosol-generating systems including the present interface elements are described with reference to FIGS. 8, 9A-9C, and 10A-10C. It should be understood that any feature described with reference to a particular configuration optionally may be, but need not necessarily be, combined with any other features described with reference to that configuration or any other configuration described herein.

FIG. 3 is a schematic illustration of a cross-section of an exemplary interface element 300 that may be implemented as interface element 30 described with reference to FIG. 1 or interface element 30′ described with reference to FIG. 2, e.g., within an aerosol-generating device or within a peripheral device. Housing 301 illustrated in FIG. 3 is provided in any suitable component of the aerosol-generating system, and may be but need not necessarily be considered to be part of interface element 300. Housing 301 includes upper surface 302, lower surface 303, and a plurality of regions 350, 351, 352 which optionally are at least partially transparent. Interface element 300 illustrated in FIG. 3 includes a plurality of contact sensing elements 310, 311, 312, a plurality of optional light emitting elements 320, 321, 322, circuit 330, and circuit board 340. Each of the contact sensing elements 310, 311, 312 may be disposed below the lower surface 303 of housing 301 and configured to generate a respective input signal responsive to detecting contact with the upper surface 302 of housing 301. For example, each of contact sensing elements 310, 311, 312 independently may be or include a capacitive sensor, a pressure sensor, or a heat sensing element. Each of the optional light emitting elements 320, 321, 322 optionally may be disposed below the lower surface 303 of housing 301 and may be configured to transmit a respective visible light signal through one of regions 350, 351, 352 responsive to a first output signal. Circuit 330 suitably may be coupled to contact sensing elements 310, 311, 312 and configured so as to receive respective input signals therefrom. For example, each of optional light emitting elements 320, 321, 322 may be or include a light emitting diode. Circuit 330 suitably may be coupled to optional light emitting elements 320, 321, 322 and configured so as to transmit respective first output signals thereto. Optionally, circuit board 340 is a flexible printed circuit board that comprises circuit 330, contact sensing elements 310, 311, 312, and optional light emitting elements 320, 321, 322, such that the circuit, contact sensing elements, and optional light emitting elements are integrated with one another into a unitary structure.

It should be understood that contact sensing elements 310, 311, 312 may have any suitable position and configuration relative to regions 350, 351, 352 and to optional light emitting elements 320, 321, 322. For example, contact sensing elements 310, 311, 312 may be, but need not necessarily be, located completely below regions 350, 351, 352, so long as the contact sensing elements may detect (e.g., generate input signals responsive to) contact with respective regions 350, 351, 352. Similarly, optional light emitting elements 320, 321, 322 may be, but need not necessarily be, located completely below regions 350, 351, 352, so long as the light emitting elements may transmit visible light signals through respective regions 350, 351, 352. Furthermore, contact sensing elements 310, 311, 312 optionally may detect contact with regions of the upper surface 302 of housing 301 that only partially overlap, or even do not overlap, with regions through which optional light emitting elements 320, 321, 322 transmit light. Optionally, contact sensing elements 310, 311, 312 respectively may be, but need not necessarily be, stacked over light emitting elements 320, 321, 322. For example, light emitting elements 320, 321, 322, if present, may be stacked over contact sensing elements 310, 311, 312. As another example, contact sensing elements 310, 311, 312 respectively may be integrated with light emitting elements 320, 321, 322 into a single structure configured both to sense contact with the upper surface 302 of housing 301 and to transmit light through respective regions of housing 301. As still another example, one or both of contact sensing elements 310, 311, 312 and light emitting elements 320, 321, 322 may be integrated into housing 301.

FIGS. 4A-4B respectively illustrate a cross-section and a perspective view of another exemplary interface element 400. Interface element 400 suitably may be implemented as a non-limiting example of interface element 30, 30′, or 300. Housing 401 illustrated in FIGS. 4A-4B is provided in any suitable component of an aerosol-generating system, and may be but need not necessarily considered to be part of interface element 400. Housing 401 includes upper surface 402, lower surface 403, and a plurality of regions 450, 451, 452 which optionally are at least partially transparent. In the nonlimiting example illustrated in FIGS. 4A-4B, discrete regions 450, 451, 452 of housing 401 are thinner than other regions of housing 401, e.g., are sufficiently thin as to transmit a visible light signal therethrough, while other regions of housing 401 optionally are sufficiently thick as not to transmit a visible light signal therethrough. In a nonlimiting example, regions 450, 451, 452 comprise recessed portions 460, 461, 462 of housing 401.

Interface element 400 illustrated in FIGS. 4A-4B includes a plurality of input-output elements 470, 471, 472 that each includes a contact sensing element (not specifically illustrated) and a light emitting element (not specifically illustrated) that respectively may be configured such as described elsewhere herein. In one nonlimiting example, the contact sensing element of each input-output element 470, 471, 472 comprises a heat sensing element, and the light emitting element of each input-output element may be or include a light emitting diode. Each of the input-output elements 470, 471, 472 may be disposed below the lower surface 403 of housing 401 at a corresponding one of regions 450, 451, 452, configured to generate an input signal responsive to detecting contact at or near the corresponding one of regions 450, 451, 452, and configured to transmit a respective visible light signal through one of regions 450, 451, 452 responsive to a first output signal. Optionally, the interface element 400 further comprises a material disposed in recessed portions 460, 461, 462, and optionally disposed on the remaining lower surface 403 of housing 401, that is configured to change an optical property of the visible light signals respectively generated by input-output elements 470, 471, 472. For example, in the nonlimiting configuration illustrated in FIGS. 4A-4B, recessed portions 460, 461, 462 are curved such that an at least partially transparent material 490 disposed therein acts as a lens that changes a focal property of the visible light signal generated by input-output elements 470, 471, 472. Illustratively, the at least partially transparent material 490 causes focusing or defocusing of the visible light signal. Flexible circuit board 480 suitably may be coupled to, and optionally integrated with, input-output elements 470, 471, 472 and optional circuitry (not specifically illustrated) for receiving input signals from the contact sensing elements and transmitting output signals to the light emitting elements in a manner such as described elsewhere herein. Optionally, flexible circuit board 480 may be coupled to control circuitry (e.g., 13 or 33) of the aerosol-generating system, such as via one or more interconnects 491.

The interface elements provided herein may include any suitable number of contact sensing elements, and any suitable number of optional light emitting elements. For example, although the exemplary interface elements illustrated in FIGS. 3, 4A, and 4B each includes three contact sensing elements (in FIGS. 4A-4B in the form of three input-output elements), it should be understood that any interface element provided herein, including but not limited to interface element 30, 30′, 300, or 400, suitably may include one contact sensing element or more than one contact sensing elements. For example, any interface element provided herein may include two or more contact sensing elements, five or more contact sensing elements, or ten or more contact sensing elements. For example, any interface element provided herein may include between one and fifty contact sensing elements, or between one and twenty contact sensing elements, or between two and twenty contact sensing elements, or between five and twenty contact sensing elements, or between five and fifteen contact sensing elements. Optionally, although the exemplary interface elements illustrated in FIGS. 3, 4A, and 4B each is illustrated as including three light emitting elements (in FIGS. 4A-4B in the form of three input-output elements), it should be understood that any interface element provided herein, including but not limited to interface element 30, 30′, 300, or 400, suitably may include one or more contact sensing elements and zero or more light emitting elements. For example, any interface element provided herein may include two or more light emitting elements, five or more light emitting elements, or ten or more light emitting elements. For example, any interface element provided herein may include between one and fifty light emitting elements, or between one and twenty light emitting elements, or between two and twenty light emitting elements, or between five and twenty light emitting elements, or between five and fifteen light emitting elements. In some configurations, the interface element does not include any light emitting elements.

Any interface element provided herein may include the contact sensing element(s) and the optional light emitting element(s) in any suitable arrangement within the aerosol-generating system. For example, a plurality of contact sensing elements may be laterally arranged in a two-dimensional array along the housing so as to provide or suggest a regular shape, such as a polygon (e.g., a rectangle, square, triangle, pentagon, hexagon, or the like) or a curved shape (e.g., a circle or oval). For example, a two-dimensional array of contact sensing elements may be arranged so as to provide or suggest a rectangle such as illustrated in FIG. 9A-9B or 10A-10B. As another example, a plurality of light emitting elements may be laterally arranged in a two-dimensional array along the housing so as to provide or suggest a regular shape, such as a polygon (e.g., a rectangle, square, triangle, pentagon, hexagon, or the like) or a curved shape (e.g., a circle or oval). For example, a two-dimensional array of light emitting elements may be arranged so as to provide or suggest a rectangle such as illustrated in FIG. 9A-9B or 10A-10B. Optionally, the contact sensing elements and the light emitting elements (if any) are arranged in substantially the same way as one another. Illustratively, each contact sensing element and any corresponding light emitting element optionally may be fixedly coupled to one another so as to be partially or fully immovable relative to one another before or after installation in a device. Optionally, each of a plurality of contact sensing elements optionally may be fixedly coupled to one another so as to be partially or fully immovable relative to one another before or after installation in a component of an aerosol-generating system.

Regardless of the particular manner in which the contact sensing element(s) and any other elements of the interface element are coupled to one another, the interface element may be included in any suitable component of an aerosol-generating system, including but not limiting to an aerosol-generating device or peripheral device, and in any suitable element of such component. An aerosol-generating system may include an aerosol-generating device that includes an interface element, e.g., a device such as device 10 or 10′, and optionally may include one or more peripheral devices. Examples of peripheral devices that may be included in the present aerosol-generating systems include, but are not limited to, one or multiple of a charger for an aerosol-generating device, a charging case for an aerosol-generating device, a holder for one or more aerosol-generating articles, or a vending machine configured to sell the aerosol-generating device or aerosol-generating articles. Optionally, one or more of such peripheral devices may include the present interface element. In some configurations, the interface element has a consistent appearance or a consistent function, or a consistent appearance and a consistent function, in each aerosol-generating device or peripheral device (if any) in which the interface element is included.

Aerosol-generating systems including the present interface elements may be prepared in any suitable manner. FIG. 5 illustrates a flow of operations in an exemplary method 50. FIGS. 6A-6B respectively schematically illustrate a cross-section and a perspective view of an intermediate structure formed during the flow of operations of FIG. 5. FIGS. 7A-7B respectively schematically illustrate a cross-section and a perspective view of another intermediate structure formed during the flow of operations of FIG. 5. Although the operations of method 50 are described with reference to elements of aerosol-generating systems 100 and 200, elements of interface elements 300 and 400, and elements of intermediate structures such as illustrated in FIGS. 6A-6B and 7A-7B, it should be appreciated that the operations may be implemented so as to prepare any other suitably configured aerosol-generating systems, aerosol-generating devices, peripheral device, or interface elements.

Method 50 includes providing a housing comprising an upper surface, a lower surface, and an at least partially transparent region extending between the upper surface and the lower surface (51). The housing may be part of any suitable component of an aerosol-generating system, for example part of an aerosol-generating or peripheral device such as described with reference to FIGS. 1 and 2. The aerosol-generating system may include an aerosol-generating element configured to generate an aerosol using any suitable aerosol-forming substrate, such as a liquid, gel, or solid. Optionally, the housing is any suitable combination of flat, smooth, button-free, and contiguous.

In some nonlimiting configurations, operation 51 illustrated in method 50 may include forming a recess in a portion of the housing to form the at least partially transparent region. In a nonlimiting example, FIGS. 6A-6B illustrate an intermediate structure that may be formed during operation 51 that includes regions 650, 651, 652 comprise recessed portions 660, 661, 662 of housing 601 in a similar manner as regions 450, 451, 452 described with reference to FIGS. 4A-4B. Operation 51 optionally may include forming such recessed portions 660, 661, 662 in lower surface 603 of housing 601. In one nonlimiting example, forming the recessed portion of the housing comprises laser eroding the portion of the housing, e.g., laser eroding lower surface 603. Illustratively, cavities of specific shape (such as curved or a polygon) may be eroded by a laser in the inner (lower) surface of the housing, for example in regions where contact sensing elements and optional light emitting elements are to be disposed. Such laser erosion optionally may be performed to an extent that the the material is partially transparent in regions 650, 651, 652, with level of transparence selected such that the material appears opaque except when a visible light signal is being transmitted therethrough. The curved sides of recessed portions 660, 661, 662 may provide a gradient of transparence around respective regions 650, 651, 652.

Referring again to FIG. 5, method 50 includes providing an interface element (52). The interface element may include a contact sensing element configured so as to generate an input signal responsive to the contact sensing element detecting contact with the upper surface. Non-limiting, exemplary configurations for contact sensing elements are described elsewhere herein, for example with reference to FIGS. 1, 2, 3, and 4A-4B.

Optionally, providing the interface element (operation 52) includes providing a light emitting element configured to transmit a visible light signal through the at least partially transparent region responsive to an output signal. Illustratively, the light emitting element may be disposed below the lower surface. Non-limiting, exemplary configurations for light emitting elements are described elsewhere herein, for example with reference to FIGS. 1, 2, 3, and 4A-4B.

In some configurations, for example, in which method 50 includes providing a light emitting element and in which the at least partially transparent region is formed by forming a recess, an operation also may be included that disposes a material in the recessed portion of the housing. The material may be configured to change an optical property of the visible light signal generated by the light emitting element. In a nonlimiting example, FIGS. 7A-7B illustrate an intermediate structure that may be formed during such an operation in which material 690 is disposed within recessed portions 660, 661, 662 of housing 601 so as to be configured similarly as material 490 described with reference to FIGS. 4A-4B. Optionally, the material also is disposed on other portions of lower surface 603. In one nonlimiting example, a thin layer of transparent material is vertically applied, such as transparent varnish, when the inner (lower) surface is substantially horizontal so that the material 690 fills the recessed portions, and so that any material covering lower surface 603 is substantially flat. The transparent material may be dried and optionally polymerized or reticulated to provide a stable shape or form. Illustratively, this may create a magnifying lens in each of the recessed portions, that may focus or defocus any visible light signals respectively transmitted therethrough.

Method 50 illustrated in FIG. 5 includes coupling a circuit to the interface element, e.g., to the contact sensing element and (if any) the light emitting element (53). The circuit may be configured to receive the input signal from the contact sensing element and to transmit an output signal to any light emitting element. For example, in some configurations such as described with reference to FIGS. 3 and 4A-4C, the contact sensing element and (if any) light emitting element optionally are coupled to a circuit provided as part of an interface element, and the circuit is configured to communicate with control circuitry of the aerosol-generating system or device. Alternatively, the contact sensing element and (if any) light emitting element may be coupled to the control circuitry of an aerosol-generating device without such a circuit. Any other suitable circuit may be coupled to one or both of the contact sensing element and light emitting element. For example, in a manner such as described ith reference to FIGS. 4A-4B, a flexible circuit board 480 suitably may be coupled to, and optionally integrated with, input-output elements 470, 471, 472 and may include optional circuitry (not specifically illustrated) for receiving input signals from the contact sensing element(s) and transmitting output signals to any light emitting element(s) in a manner such as described elsewhere herein.

In one configuration, input-output elements 470, 471, 472 may be provided on (integrated with) flexible circuit board 480 using any suitable operations, for example using any suitable combination of semiconductor processing, printed lithography, and microlithography. The flexible circuit board 480 may include one or more polymeric materials, which may be covered by at least one layer including polymeric or metallic materials or both to form a laminated structure. Optionally, thin film electroluminescent displays technology may be used that incorporates light sources and sensors. The flexible circuit board 480 may be applied in such a way that its position with reference to recessed portions 660, 661, 662 makes the light emitting elements geometrically substantially coincident with the centers of the respective recessed portions. The flexible circuit board may mechanically be coupled to the housing, or may be fastened by adhesive, such as using an adhesive coating deposited in locations outside of recessed portions 660, 661, 662.

Aerosol-generating systems, aerosol-generating devices, peripheral devices, and interface elements such as described herein may be configured, and may be used, in any suitable manner so as to receive information from a user, to convey information to a user, or to both receive information from a user and convey information to a user.

For example, any of the aerosol-generating systems provided herein (such as systems 100 or 200) may include a housing that comprises an upper surface, a lower surface, and a plurality of regions (such as housing 11, 21, 39, 401, or 601). The aerosol-generating system may include a plurality of contact sensing elements (such as contact sensing elements 310, 311, 312, or input-output elements 470, 471, 472). The contact sensing elements may be configured to generate a respective input signal responsive to detecting contact with the upper surface of the housing at or near a respective one of the regions (such as regions 350, 351, 352, or regions 450, 451, 452, or regions 650, 651, 652). The aerosol-generating system may include a circuit configured to receive the respective input signals from the contact sensing elements (such as control circuitry 13, control circuitry 33, or circuit 330). The circuit optionally further may be configured to enable a first function of the aerosol-generating system responsive to a first plurality of the respective input signals satisfying a first criterion.

Any suitable function of the aerosol-generating system may be enabled, by the circuit, responsive to any suitable criterion or criteria, for example responsive to any suitable number of respective input signals satisfying any suitable criterion or criteria. The satisfaction of such criterion or criteria can be considered to authenticate the user to the aerosol-generating system. In some configurations, the aerosol-generating system can be configured so as to authenticate the user using a one-step procedure. In other configurations, the aerosol-generating system can be configured so as to authenticate the user using a multiple-step procedure, such as a two-step authentication procedure or a three-step authentication procedure.

An exemplary multiple-step procedure that may be implemented by an aerosol-generating system may include detecting an interaction with a user and determining whether the interaction is with an approved user or type of user. Such determination may include, for example, any suitable combination of one or more of: comparing an area of thermal contact to a stored area of thermal contact; using an array of sensors (such as contact sensors) to detect contact; using a fingerprint sensor to receive a fingerprint and comparing that fingerprint to a stored fingerprint; or using voice recognition technology, e.g., having the system ask the user a question, receiving a voice sample from the user in response to that question, and comparing the voice sample to prestored voice information (such as determining that the voice is below a certain frequency, or belongs to a particular user, or other determination such as commonly done in telephone banking technology). As a consequence or in dependence on such determination, in some configurations the system either may take no further action (for example, if the user is not approved or is not of an approved type of user) or may be enabled to receive additional input from the user, for example a second user input of some expected information stored in a memory which could be or include any suitable combination of one or more of: a password or code (such as a touch pattern input by the user tapping different lights of the present interface element, or inputting a code or password into a touch screen or buttons); or a voice command (such as the user saying a specific word, or similar to technology used by telephone banking where a user's voice is detected as belonging to that user and not someone else). If the user input matches an expected user input, activation of the aerosol-generating system or a component thereof, in particular, activation of the aerosol-generating element, is enabled. If the user input is incorrect, then activation of the aerosol-generating element is blocked. The various user inputs respectively can be incorporated into any suitable component or components of the aerosol-generating system, including any suitable one or ones of an aerosol-generating device or a peripheral device.

FIGS. 9A-9C and 10A-10C are schematic illustrations of exemplary uses of the present interface elements. The interface elements may be provided in any suitable component of an aerosol-generating system.

Exemplary functions that may be enabled, by the circuit, include, but are not limited to, actuating an aerosol-generating element of the system, or initiating an authentication procedure. Optionally, the first criterion optionally comprises the circuit receiving a predefined number of the respective input signals at the same time as one another. For example, FIGS. 9A-9C illustrate a device 900, e.g., an aerosol-generating device or a peripheral device, of an aerosol-generating system that includes the present interface element, including a plurality of contact sensing elements (not specifically illustrated) and optionally a plurality of light emitting elements 920. The contact sensing elements may be distributed across any suitable portion of device 901. For example, as shown in FIG. 9A, prior to detecting contact of a user's body part, such as finger, palm, or lip, with the upper (outer) surface of the housing 901 of device 900, one or more functionalities of the device may be disabled by a circuit (not specifically illustrated). For example, one or more unauthorized users may be inhibited from using one or more functionalities of the device. As shown in FIG. 9B, the user's finger(s) or palm 910 may contact the upper surface of the housing 901. A plurality of the contact sensing elements may detect such contact, and may generate respective input signals responsive thereto which are transmitted to the circuit. The circuit is configured to determine whether the received signals satisfy a predetermined criterion, for example, whether a predefined number of the received signals have been received by the circuit. The predefined number may, in one nonlimiting example, be the number of signals expected to be generated responsive to contact of the upper surface of the housing 901 with the hand of a specified user or of a user of an approved type of user. As one nonlimiting example, the predefined number can correspond to the contact spanning more than 30% of the surface area of the housing, preferably more than 40% of the surface area of the housing, preferably more than 50% of the surface area of the housing, or preferably more than 60% of the surface area of the housing, where for this purpose the surface area of the housing may be considered to be just this upper (outer) surface, rather than the entire outer surface area spanning all faces of the aerosol-generating system. These or any other suitable criterion or criteria may provide or be a part of an authentication procedure.

As shown in FIG. 9C, the circuit determines that the received signals satisfy the criterion, for example, that the number of signals received by the circuit corresponds to a number of signals expected to be generated by contact of the upper surface of housing 901 with a specified user or of an approved type of user. Responsive to determining that the received signals satisfy the criterion, the circuit enables a first function of the aerosol-generating system. For example, in FIG. 9C, the first function that the circuit enables optionally is generation of visible light signals by a plurality of the light emitting elements. Enabling such function may, for example, include the circuit transmitting the respective output signal to a first plurality (e.g., a predefined subset, or all) of the light emitting elements so as to cause the plurality of the light emitting elements to transmit respective visible light signals through respective ones of the regions, such as shown in FIG. 9C.

The circuit may use any other suitable criterion to enable a suitable function of the aerosol-generating system. In another example, the criterion comprises the circuit receiving predefined ones of the respective input signals in a predefined sequence. For example, in the device 1000 (e.g., an aerosol-generating device or a peripheral device of an aerosol-generating system) configured such as illustrated in FIG. 10A, a plurality (e.g., a predefined subset, or all) of the light emitting elements generate respective visible light signals, optionally responsive to operations such as described with reference to FIGS. 9A-9C. The user may touch regions of the upper surface of housing 1001 corresponding to predefined ones of the contact sensing elements in a predefined sequence, causing such contact sensing elements to generate the respective input signals in a predefined sequence. The predefined sequence of respective input signals may be considered to be an authentication code, and optionally may be predefined by the user and stored in computer-readable memory in operable communication with the circuit.

The circuit may be configured, responsive to receiving the predefined sequence of respective input signals, to enable a second function of the aerosol-generating system. For example, one or more additional or different light emitting elements may caused to generate (or not generate) visible light signals, or one or more wavelengths of such visible light signals may be changed. For example, as illustrated in FIG. 10B, the circuit causes predetermined ones of the light emitting elements to generate visible light signals, responsive to receiving the predefined sequence of respective input signals. The circuit optionally may enable one or more further functions of the aerosol-generating system responsive to one or more further criteria. For example, another criterion may include the circuit receiving predefined ones of the respective input signals in a second predefined sequence. For example, the user again may touch regions of the upper surface of housing 1001 corresponding to predefined ones of the contact sensing elements in a predefined sequence, causing such contact sensing elements to generate the respective input signals in a predefined sequence. Optionally, the contact sensing elements of this predefined sequence correspond to the light emitting elements which are generating visible light signals in FIG. 10B. Responsive to receiving this predefined sequence, any further function may be enabled. For example, as illustrated in FIG. 100, the circuit causes predetermined ones of the light emitting elements to generate visible light signals, responsive to receiving the predefined sequence of respective input signals. In this nonlimiting example, the same light emitting elements are generating visible light signals as in FIG. 10B, but the visible light signals generated by one or more of such light emitting elements include a different colour than one another.

As another example of a function that may be enabled by the circuit responsive to any suitable criterion being satisfied, such as one or more criteria described with reference to FIGS. 9A-9C and 10A-10C (any of which criteria may be considered to provide an authentication procedure, and optionally may be predefined by the user and stored in computer-readable memory in operable communication with the circuit), includes actuating the aerosol-generating element of the aerosol-generating system.

Illustratively, FIG. 8 illustrates a flow of operations in an exemplary method of using an aerosol-generating system. Method 80 illustrated in FIG. 8 may include generating, by a plurality of contact sensing elements (such as contact sensing elements 310, 311, 312, or input-output elements 470, 471, 472), a plurality of input signals responsive to detecting contact with an upper surface of a housing at or near respective regions of the housing (81). Method 80 illustrated in FIG. 8 also may include receiving, by a circuit (such as control circuitry 13, control circuitry 33, or circuit 330), the plurality of input signals (82). Method 80 also may include enabling, by the circuit, a function of the aerosol-generating system responsive to the plurality of input signals satisfying a criterion (83). Exemplary functions and exemplary criteria are described elsewhere herein.

As such, the present aerosol-generating systems, interface elements, and methods may reduce or eliminate the use of buttons or other mechanical interface elements. Optionally, the present aerosol-generating systems, interface elements, and methods may enable the secure use of an aerosol-generating system after an authentication process. Optionally, the present aerosol-generating systems, interface elements, and methods may be customizable by the user, e.g., provide for user-defined sequences of contacting the upper surface of the housing which may be used to enable one or more functions of the aerosol-generating system.

Although some configurations of the present interface elements have been described in relation to an aerosol-generating system comprising an aerosol-generating device and a separate but connectable aerosol-generating article, it should be clear that the interface elements suitably may be provided in a one-piece aerosol-generating system.

It should also be clear that alternative configurations are possible within the scope of the invention. For example, the present interface elements suitably may be integrated into any type of device or system, and are not limited to use in aerosol-generating devices or aerosol-generating systems. Illustratively, the present interface elements may be included in medical devices, smartphones, or the like.

1.-20. (canceled)

21. An aerosol-generating system, comprising:
an aerosol-generating element;
a housing comprising an upper surface, a lower surface, and a plurality of regions;
an interface element comprising a plurality of contact sensing elements, each contact sensing element being configured to generate an input signal responsive to that contact sensing element detecting contact with the upper surface at or near one of the plurality of regions; and
a circuit configured to receive the input signals from the plurality of contact sensing elements and to enable a first function of the aerosol-generating system responsive to a first plurality of the input signals satisfying a first criterion, satisfaction of the first criterion being part of a multi-step authentication procedure,
wherein the first criterion comprises the circuit receiving a predefined number of the input signals simultaneously.

22. The aerosol-generating system according to claim 21, wherein the predefined number corresponds to a number of input signals expected to be generated by contact with the upper surface by a specified user or an approved type of user.

23. The aerosol-generating system according to claim 21, wherein the predefined number corresponds to a number of input signals expected to be generated by contact with the upper surface by a hand of at least a predetermined size.

24. The aerosol-generating system according to claim 21, wherein the predefined number corresponds to a number of input signals generated by contact with a predetermined proportion of a surface of the housing.

25. The aerosol-generating system according to claim 21, wherein the predefined number corresponds to a number of input signals generated by contact with a predetermined proportion of the upper surface of the housing or of a portion of the upper surface of the housing.

26. The aerosol-generating system according to claim 21, wherein at least one of the plurality of contact sensing elements comprises a heat sensing element.

27. The aerosol-generating system according to claim 21, wherein at least one of the plurality of contact sensing elements comprises a capacitive sensor.

28. The aerosol-generating system according to claim 21, wherein at least one of the plurality of contact sensing elements comprises a pressure sensor.

29. The aerosol-generating system according to claim 21, wherein the first function is initiation of an authentication procedure.

30. The aerosol-generating system according to claim 21, wherein the circuit is further configured to enable the first function if an alternative authentication procedure to satisfying the first criterion is successfully completed.

31. The aerosol-generating system according to claim 21, wherein the first criterion further comprises receiving a second predefined number of input signals from the plurality of contact sensing elements indicative of contact with the upper surface for greater than a predetermined length of time.

32. The aerosol-generating system according to claim 31, wherein the first criterion further comprises receiving the second predefined number of input signals from the plurality of contact sensing elements indicative of contact with the upper surface for less than a second predetermined length of time.

33. The aerosol-generating system according to claim 21, wherein the first criterion further comprises simultaneously receiving a first predefined number of input signals responsive to detecting contact with the upper surface at or near a first region of the plurality of regions and a second predefined number of input signals responsive to detecting contact with the upper surface at or near a second region of the plurality of regions.

34. The aerosol-generating system according to claim 33, wherein the first criterion further comprises simultaneously receiving an nth predefined number of input signals responsive to detecting contact with the upper surface at or near an nth region of n regions of the plurality of regions, where n is an integer greater than 2.

35. The aerosol-generating system according to claim 33, wherein the first criterion further comprises simultaneously receiving at least one input signal responsive to detecting contact with the upper surface at or near at least a predetermined proportion of n regions of the plurality of regions.

36. The aerosol-generating system according to claim 34, wherein n is an integer greater than 10 and each of the n regions is separated from every other region of the n regions by at least 1 millimeter.

37. The aerosol-generating system according to claim 21,
wherein the first criterion further comprises simultaneously receiving at least one input signal generated by a contact sensing element detecting contact with a first portion of the upper surface and at least one input signal generated by a contact sensing element detecting contact with a second portion of the upper surface, and
wherein the first portion of the upper surface and the second portion of the upper surface are non-co-planar.

38. The aerosol-generating system according to claim 21, wherein the housing is button-free.

39. A method of operating an aerosol-generating system comprising an aerosol-generating element, the method comprising:
generating, by an interface element comprising a plurality of contact sensing elements, a plurality of input signals responsive to detecting contact with an upper surface of a housing at or near respective regions of the housing;
receiving, by a circuit, the plurality of input signals; and
enabling, by the circuit, a first function of the aerosol-generating system responsive to the plurality of input signals satisfying a first criterion, satisfaction of the first criterion being part of a multi-step authentication procedure,
wherein the first criterion comprises the circuit receiving a predefined number of the input signals simultaneously.
